(19) United States
(12) Patent Application Publication
(10) Pub. No.: US 2022/0162366 A1
(43) Pub. Date: May 26, 2022

(54) POLYMERISABLE COMPOSITION FOR BONDING FIBRE UNITS

(71) Applicant: RUDOLF GMBH, Geretsried (DE)

(72) Inventors: Raman Paul SINGH, Geretsried (DE); Dirk SIELEMANN, Wolfratshausen (DE); Ludwig HUBER, München (DE)

(73) Assignee: RUDOLF GMBH, Geretsried (DE)

(21) Appl. No.: 17/531,942

(22) Filed: Nov. 22, 2021

(30) Foreign Application Priority Data
Nov. 24, 2020 (EP) 20 209 550.1

(51) Int. Cl. C08F 265/06; C08F 283/00; D06M 10/00; D06M 10/10

(52) U.S. Cl. CPC C08F 265/06; D06M 10/10; D06M 10/001; C08F 283/008

(57) ABSTRACT

The present invention relates to a polymerisable composition for bonding fibre units, in particular linear textiles such as filaments, yarns, twines or ropes, comprising at least one prepolymer having at least two polymerisable vinylidene groups, such as a polyurethane having at least two (meth)acrylate groups, at least one photoinitiator and at least one compound having at least one polymerisable vinylidene group with a weight average molecular weight of 70-800 g/mol. In addition, the present invention relates to a process for bonding fibre units, comprising applying the composition according to the invention to at least one fibre unit such as a filament, yarn, twine or rope and irradiation of the fibre unit thus obtained with radiation having a wavelength in the range of, for example, 100-450 nm.

### SUBJECT OF THE INVENTION

The present invention relates to a polymerisable composition for bonding fibre units, in particular linear textiles such as filaments, yarns, twines or ropes, comprising at least one prepolymer having at least two polymerisable vinylidene groups, at least one photoinitiator, and at least one compound having at least one polymerisable vinylidene group which has a weight average molecular weight M_{w} of 70-800 g/mol.

The invention further relates to a polymer that is obtained by polymerising, in particular by irradiating, the composition according to the present invention.

In addition, the present invention relates to a method of bonding fibre units, in particular linear textiles, comprising applying the composition according to the present invention to at least one fibre unit such as a filament, yarn, twine or rope, and irradiating the fibre unit obtained thereby.

### PRIOR ART

Commercially available sewing threads are produced by twisting and plying, respectively, many individual threads or filaments into a thread bundle or multifilament with a helix-like structure. This usually results in a number of turns of approx. 1000 to 10000 turns per metre of sewing thread.

In some cases, such a sewing thread has a core, which may be made of any suitable tensile strength material compatible with the material of the twisted or plied threads or filaments.

For example, the threads or filaments may be made of cotton, wool, silk, viscose, polyester, polyamide, polyurethane, polypropylene, polyethylene, polyacrylonitrile and/or polytetrafluoroethylene. The core may contain cotton, elastane, Kevlar, carbon fibre and/or glass fibre. The core may preferably comprise the same material as the threads or filaments.

In continuous sewing operation, sewing threads are sewn by machine at up to 300 sewing strokes per minute. In this process, conventional yarns or sewing threads, respectively, tend to become untwisted due to alternating re-feeding and frequently varying thread tension, i. e. they have threads/filaments that detach from the main strand of the sewing thread. Slings or loops can form from these detached threads/filaments and, due to the needle friction, also splits in the yarn. These defects can be caught by the sewing machine needle during further sewing and lead to irregular, inferior seams. Often, even thread breakage and needle breakage occur as a result of such unravelling. In addition, sewing threads in warp stitch seams can also untwist at their ends due to the torsional stress prevailing during the sewing process.

In order to reduce the above-mentioned problems, various solution approaches are described. In this regard, the aim is to bond the individual filaments/threads together (by so-called bonding of the yarn) in order to obtain a yarn that withstands the high mechanical stresses during sewing, but still has good processability.

DE 37 17 921 A1 relates to a yarn which is bonded by means of a hot-melt adhesive thread in order to obtain an adhesion of the individual filaments/fibres to each other and thus a fibre composite. DE 43 27 783 A1 relates to a sewing thread which is first treated with an aqueous, film-forming polymer dispersion or solution. The polymers remaining after thermal drying bond the filaments/fibres to form a fibre composite. The application of aqueous polyurethane dispersions is also known.

One problem with finishing from the aqueous medium is the need to remove the water by thermal treatment. Drying causes high energy costs, a high water consumption as well as a high area consumption for the required plant technology (cf. FIG. 1A). In addition, the application on thermally unstable yarns is often not possible due to the high drying temperatures required.

Another problem underlying the use of aqueous polymer dispersions, in particular those based on polyurethanes, is that the polymer migrates to the yarn surface when the water evaporates. Initially, a polymer film is formed on the surface, which coats the yarn and prevents further evaporation of the water. When water vapour subsequently escapes, bubbles form on the yarn surface, which partially burst and, when completely dry, form defects such as bumps and small particles on the bonded yarn surface. This so-called “cratering” leads to disadvantageous properties for the bonded yarn. On the one hand, the microparticles on the surface cause increased friction and, on the other hand, polymer material on the surface is removed during subsequent sewing. This abrasion is known to the skilled person as the “snowing effect”.

Furthermore, in the case of an application from the aqueous medium, not the entire amount of the applied polymer is used for bonding, since the polymer material is not distributed over the entire cross-section of the yarn, but is located for the most part on the yarn surface due to e. g. migration effects as described above, and thus contributes only insignificantly to the bonding of the fibres/filaments of the yarn.

Although the problems described above can be reduced by optimising the application parameters, such as liquor concentration, yarn speed in the bonding device, dryer temperature, dryer length, air humidity and ventilation volumes, they cannot be completely avoided. In addition, optimisation is difficult and time-consuming and has to be carried out individually for each yarn and polymer dispersion.

WO 2018/130586 A1 describes solvent-based coatings based on polyurethane ureas for textile materials such as natural fibres. However, even small amounts of organic solvents are not desirable on textiles.

U.S. Pat. No. 6,436,484 B1 describes a method for coating sewing thread. The process comprises the application of a solvent-free, radiation-curable composition comprising a cycloaliphatic epoxide and a photoinitiator. After irradiation of the composition, a proton is generated which initiates a cationic polymerisation. However, epoxy bondings have the disadvantage that they take a comparatively long time to cure and, in the case of incomplete curing, lead to sticking of the bonded yarn in the wound-up state. In addition, the photoinitiators used are very sensitive to impurities on the substrate to be applied, so that polymerisation may be incomplete. Furthermore, separate storage of photoinitiator and polymer is required.

It is therefore the object of the present invention to provide an improved bonding method for fibre units such as sewing threads, which overcomes the disadvantages of the methods described in the prior art. In particular, a more homogeneous distribution of the bonding composition on and in the fibre unit is ensured. The bonding composition can be applied by a simple, fast and inexpensive method and does not have any adverse effects such as “cratering” and in particular “snowing”.

This task was solved by the composition according to the present invention, comprising (i) at least one prepolymer having at least two polymerisable vinylidene groups, (ii) at least one photoinitiator, and (iii) at least one compound having at least one polymerisable vinylidene group, wherein component (iii) has a weight average molecular weight M_{w} of 70-800 g/mol, preferably 100-500 g/mol, more preferably 100-450 g/mol.

The composition is suitable for bonding fibre units such as filaments, yarns, twines or ropes by means of photopolymerisation. Thus, the disadvantageous use of water and/or organic solvents and the negative effects on the properties of the bonded fibre unit associated therewith can be avoided.

By applying preferably water- and solvent-free photopolymerisable compositions to fibre units such as yarns and subsequent irradiation, bonded fibre units can be produced which do not have “cratering”, have a high mechanical strength and are characterised by very good sewing properties. The mechanical strength is particularly ensured by the fact that the bonding of the fibre reduces the friction within the sewing process and thus there are fewer fibre breaks. In addition, it is possible to provide significantly higher coating quantities of the bonding composition, so that the desired stability of the yarn can be set as desired.

In addition, the composition according to the present invention enables bonding of heat-sensitive yarns, as there is no need for thermal drying of the yarn, which usually takes place at temperatures above 150° C.

The composition according to the present invention has a low viscosity, which allows easy handling of the composition and good application, high reactivity as well as improved penetration behaviour into the fibre composite, so that good adhesion between the individual fibres or filaments, respectively, can also be obtained inside the fibre unit.

Furthermore, the consumption of water and energy is significantly reduced, as no complex drying process is required. In addition, it is possible to work at higher process speeds, so that productivity is significantly increased compared to slow thermal drying processes.

### Definitions

As used herein, the term “bonding” refers to the adhesion and coating of a fibre unit, particularly a linear textile such as a filament, yarn, twine or rope. The bonding causes a strengthening against the mechanical stress during the processing of the fibre unit. In particular, untwisting during sewing processes can be prevented.

“Cratering” refers to defects on the bonded yarn surface such as bumps and small particles.

“Fibres” mean natural fibres as well as synthetic fibres and mixed forms. “Natural fibres” consist of naturally occurring materials and preferably include cotton, wool, linen and/or silk. “Synthetic fibres” or also referred to as “artificial fibres” are synthetically produced from natural polymers, such as in cellulosic (chemical) fibres, and/or synthetic polymers and preferably comprise polymers such as polyester, polyolefin, e. g. polyethylene or polypropylene, preferably polypropylene, polyamide, polyaramide, such as Kevlar® and Nomex®, polyacrylonitrile, elastane and/or viscose. Blended forms comprise natural and synthetic fibres.

“Fibre unit” means a filament, yarn, twine or rope. These may consist of the fibres as mentioned above.

“Uniform distribution” of the applied composition along its cross-section means that the interior of the fibre has substantially the same mass amount of bonding composition as the exterior of the fibre.

“Inert atmosphere” means a gaseous atmosphere which does not react with the coating compositions and does not affect their curing even under harsh conditions, e. g. at elevated temperature and high-energy irradiation. In particular, this is understood to mean an atmosphere with a low oxygen content, preferably 0.01-5% by volume. A suitable inert atmosphere comprises, for example, nitrogen or argon.

“Filament” is the term for a fibre having a length/width ratio greater than 3. The length of the filament is preferably at least 10 m, more preferably at least 1000 m. Filaments may be present as monofilament or polyfilament. Monofilaments consist of a single fibre. Polyfilaments consist of at least 2 monofilaments, in particular at least 10 monofilaments and preferably 30-100 monofilaments.

“Free of solvents” or “substantially free of solvents” means that the composition comprises less than 10% by weight, in particular 0.001-5% by weight, preferably less than 2% by weight of solvent with respect to the total weight of the composition. Solvents in the sense of the present invention are in particular compounds which do not contribute to the chemical molecular structure of the polymer according to the invention.

“Yarns” consist of several fibres, which may be plied, and “twines” are obtained by twisting together at least two yarns.

“Linear textiles” refers to filaments, yarns such as fancy yarns, plain yarns, textured yarns, multiple wound yarns, spun yarns, rotor yarns, tricylinder yarns, worsted yarns, semi-worsted yarns, carded yarns, schappe yarns, bourette yarns and filament yarns such as multifilament yarns and monofilament yarns, twines such as fancy twines, single stage twines, multi stage twines, covering twines and continuous twines, ropes, fibres such as staple fibres and fibre bundles, and filament silk of natural material, semi-synthetic material, synthetic material or a mixture thereof.

The term “(meth)acrylate” means “acrylate or methacrylate”.

“Rope” means an element made of natural and/or synthetic fibres which are twisted and/or braided together, wherein the rope can be subjected to tensile force and preferably has a diameter of 1-10 mm, for example up to about 5 mm.

“Photoinitiator” means a compound which, when exposed to radiation, forms radicals that can initiate free-radical polymerisation.

“Photopolymerisation” means the polymerisation of polymerisable compounds by means of electromagnetic radiation, preferably UV light having a wavelength in the range of from 100 to 450 nm. The radiation dose commonly used for cross-linking in a photopolymerisation is in the range of from 80-3000 mJ/cm².

“Photopolymerisable compounds” are compounds with one or more photopolymerisable groups, in particular ethylenically unsaturated groups such as vinylidene groups. Photopolymerisable compounds polymerise under the action of photochemically generated radicals (see above).

“Polymerisation inhibitor” refers to a compound that prevents the autopolymerisation of monomers by forming inactive radicals with reactive radicals. It thereby increases the storage stability of radically polymerisable substances and mixtures of substances.

“Reactive diluent” or “reactive diluting agent” means a compound that reduces the viscosity of a composition and becomes part of the polymer when the composition is polymerised.

A “prepolymer” according to the present invention is a polymer or oligomer capable of entering into a polymerisation via at least two polymerisable groups and thereby contributing more than one monomer unit to the resulting polymer.

An “oligomer” according to the present invention is a molecule comprising at least 2 monomer units. The monomer units may be identical or different.

“Free of water” or “substantially free of water” means that the composition comprises less than 10% by weight, in particular 0.001-5% by weight, preferably less than 2% by weight of water with respect to the total weight of the composition.

### FIGURES

FIG. 1 is a schematic illustration of yarn bonding methods. FIG. 1A shows the application of an aqueous bonding composition according to the prior art to a yarn followed by thermal drying by IR radiation and hot air. FIG. 1B shows the application of a composition according to the present invention with photopolymerisable compounds to a yarn, whereby no drying step by IR radiation and/or hot air is required.

FIG. 2 shows the cut ends of an unbonded yarn and a yarn that is bonded with the composition according to the present invention.

FIG. 3 shows the set-up of an abrasion test. A motor (M) lets the yarn slide back and forth over an abrasive metal rod (A), whereby at the loose end of the yarn a weight (G) of 150 g is attached.

FIG. 4 shows the cut ends of an unbonded yarn, a yarn bonded with the composition according to the present invention and a yarn bonded with the composition according to the present invention after an abrasion test has been carried out.

FIG. 5 shows the surface of an unbonded yarn (top), a yarn bonded with an aqueous PU dispersion (middle) and a yarn bonded with the composition according to the present invention (bottom).

FIG. 6 shows a yarn bonded with the composition according to the present invention (left), and a yarn bonded with an aqueous PU dispersion (right). In the right picture, traces of cratering are clearly visible.

### DETAILED DESCRIPTION OF THE INVENTION

The present invention relates to a composition comprising:

(i) at least one prepolymer having at least two polymerisable vinylidene groups, wherein component (i) preferably has a weight average molecular weight M_{w} of 2000-50000 g/mol, more preferably 4000-10000 g/mol,

(ii) at least one photoinitiator, and

(iii) at least one compound having at least one polymerisable vinylidene group, wherein component (iii) has a weight average molecular weight M_{w} of 70-800 g/mol, preferably 100-500 g/mol, more preferably 100-450 g/mol.

The at least two polymerisable vinylidene groups of a prepolymer of component (i) are preferably photopolymerisable and may each be independently selected from a (meth)acrylate, vinyl and allyl group. In one embodiment, the at least two polymerisable vinylidene groups of a prepolymer of component (i) are each independently selected from a vinylidene group-containing carboxylic acid, carboxylic acid ester or carboxylic acid amide group, such as a (meth)acrylic acid, crotonic acid, itaconic acid, fumaric acid, maleic acid, acrylamidoglycolic acid, methacrylamidoglycolic acid group and esters or amides thereof and in particular from a (meth)acrylic acid ester group and (meth)acrylic acid amide group, such as a crotonic acid, itaconic acid, fumaric acid, maleic acid, acrylamidoglycolic acid and methacrylamidoglycolic acid ester or amide group. In a preferred embodiment, the at least two polymerisable vinylidene groups in a prepolymer of component (i) are (meth)acrylate groups.

The composition according to the invention comprises at least one prepolymer having at least two polymerisable vinylidene groups (component (i)). In a preferred embodiment, component (i) comprises at least two, preferably 2-5, in particular two different prepolymers having at least two polymerisable vinylidene groups.

The at least one polymerisable vinylidene group of a compound of component (iii) is preferably photopolymerisable and may each be independently selected from a (meth)acrylate, vinyl and allyl group. In one embodiment, the at least one polymerisable vinylidene group of a compound of component (iii) is selected from a vinylidene group-containing carboxylic acid, carboxylic acid ester or carboxylic acid amide group, such as a (meth)acrylic acid, crotonic acid, itaconic acid, fumaric acid, maleic acid, acrylamidoglycolic acid, methacrylamidoglycolic acid group and esters or amides thereof and in particular from a (meth)acrylic acid ester group and (meth)acrylic acid amide group, such as a crotonic acid, itaconic acid, fumaric acid, maleic acid, acrylamidoglycolic acid and methacrylamidoglycolic acid ester or amide group. In a preferred embodiment, the at least one polymerisable vinylidene group in component (iii) is a (meth)acrylate group, in particular a methacrylate group. Preferably, all polymerisable vinylidene groups present in the composition are (meth)acrylate groups.

A prepolymer having at least two polymerisable vinylidene groups comprises two or more polymerisable vinylidene groups, such as two, three, four or more, preferably two polymerisable vinylidene groups. In a preferred embodiment, component (i) comprises one or more prepolymers each having two polymerisable vinylidene groups, in particular two prepolymers each having two polymerisable vinylidene groups.

The prepolymer having at least two polymerisable vinylidene groups may have a weight average molecular weight M_{w} of 2000-50000 g/mol, preferably 4000-20000, more preferably 4000-10000 g/mol, the weight average molecular weight M_{w} being determined by gel permeation chromatography using tetrahydrofuran as eluent and polystyrene as standard for calibration at a column temperature of 30° C.

The viscosity of the component (i) may be 100-120,000 mPa·s, preferably 1,000-100,000 mPa·s, more preferably 10,000-70,000 mPa·s and in particular 5,000-70,000 mPa·s measured at 60° C. according to DIN 2555. In one embodiment, the component (i) comprises a prepolymer having at least two polymerisable vinylidene groups, which has a viscosity of 10,000-100,000 mPa·s, preferably 30,000-70,000 mPa·s and more preferably 50,000-65,000 mPa·s measured at 60° C. according to DIN 2555, and/or a prepolymer having at least two polymerisable vinylidene groups, which has a viscosity of 10,000-100,000 mPa·s, preferably 20,000-80,000 mPa·s and in particular 30,000-70,000 mPa·s measured at 60° C. according to DIN 2555.

The prepolymer having at least two polymerisable vinylidene groups of the component (i) may be selected from macromonomers, oligomers or polymers. Preferably, the prepolymer having at least two polymerisable vinylidene groups is a polycarbonate, polyether, polyester, polyurethane or a polyurethane-urea compound, preferably a polyurethane, polyester or a polyurethane-urea compound, even more preferably a polyurethane or a polyurethane urea compound, which has at least two polymerisable vinylidene groups. Preferably, the prepolymer having at least two polymerisable vinylidene groups is a polycarbonate, polyether, polyester, polyurethane or a polyurethane urea compound, each having at least two, more preferably two, (meth)acrylate groups.

Alternatively, the prepolymer having at least two polymerisable vinylidene groups may be based on sugar polymers, such as cellulose derivatives, for example hydroxyalkylcellulose, carboxyalkylcellulose, gum arabic, chitosan, alginate, guar gum, xanthan gum, gelatin, starch, or agar, or polypeptides such as polylysine reacted with a vinylidene-containing carboxylic acid such as acrylic acid, methacrylic acid, crotonic acid, itaconic acid, fumaric acid, maleic acid, acrylamidoglycolic acid or methacrylamidoglycolic acid or the corresponding acid halides or esters thereof.

Alternatively, the prepolymer having at least two polymerisable vinylidene groups may be based on vegetable oil, such as castor oil, linseed oil, soybean oil, tall oil, pine oil, shoot oil, vernonia oil, lesquerella oil, bladder shell oil, cashew shell oil or other vegetable oils which are rich in unsaturated fatty acids. Preferably, the vegetable oil-based prepolymer is epoxidised and functionalised with at least two (meth)acrylates each.

Particularly preferably, the prepolymer having at least two polymerisable vinylidene groups is a polyester (meth)acrylate or polyurethane (meth)acrylate or polyurethane urea (meth)acrylate each having at least two (meth)acrylate groups.

In one embodiment, a prepolymer having at least two polymerisable vinylidene groups is obtained by reacting an at least twice hydroxy functional compound (X) with a vinylidene-containing compound, such as (meth)acrylic acid, acryloyl chloride, methacryloyl chloride, glycidyl (meth)acrylate or 2-isocyantoethyl (meth)acrylate.

Compound (X) is selected, for example, from diols, polyols, and at least dihydroxy-functional polyesters, polycarbonates, and polyethers.

In one embodiment, compound (X) may be selected from
polyols, such as trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxite), xylitol, dulcitol (galactitol), maltitol or isomaltitol, which are alkoxylated with alkylene oxide building blocks, e. g. derived from ethylene oxide, propylene oxide, iso-butylene oxide, 1-butene oxide, 2-butene oxide, vinyloxirane, styrene oxide and epichlorohydrin
polyetherdiols which may be built up from alkylene oxide building blocks and are derived, for example, from cyclic precursors such as ethylene oxide, propylene oxide, iso-butylene oxide, 1-butene oxide, 2-butene oxide, vinyloxirane, styrene oxide, epichlorohydrin and mixtures thereof. Suitable polyetherdiols may also be composed of several of the above building blocks. Preferred are polyethylene glycol with a molecular weight of 722-2000 g/mol, polypropylene glycol with a molecular weight of 714-2000 g/mol, polytetrahydrofuran with a molecular weight between 739-2000 g/mol, poly-1,3-propanediol with a molecular weight of 714-2000 g/mol, and
polyester polyols, preferably prepared by reaction of diols/polyols with dicarboxylic acids/dianhydrides. Suitable diols/polyols include, but are not limited to, the diols, polyols and polyether diols mentioned herein. Suitable dicarboxylic acids are, for example, aliphatic, cycloaliphatic, araliphatic, aromatic or hetercyclic and are optionally substituted with halogens, in particular F, Cl or Br. Suitable dicarboxylic acids are in particular oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid, tetrahydro-phthalic acid and cork acid. Suitable dianhydrides are, for example, phthalic acid anhydride, tetrahydrophthalic acid anhydride, hexahydrophthalic acid anhydride, tetrachlorophthalic acid anhydride, endomethylene tetrahydrophthalic acid anhydride, glutaric acid anhydride, maleic acid anhydride and succinic acid anhydride.
polycarbonate polyols, which are preferably obtained by condensation of diaryl carbonates with diols or polyols or by reaction of diols and polyols with phosgene. Preferred diols/polyols are bisphenol A, bisphenol S, dihydroxydiphenyl sulfide, tetramethylbisphenol A, 1,1-bis(4-hydroxyphenyl)-3,3,5-trimethylcyclohexane and 1,1,1-tris(4-hydroxyphenyl)ethane. Preferred diaryl carbonates are diphenyl carbonate and ditolyl carbonate or carbonates derived from other aromatic compounds such as cresols, chlorophenols, methoxyphenols, alkylphenols and naphthols.

In one embodiment, a prepolymer having at least two polymerisable vinylidene groups is obtained by the reaction of a polyepoxidised compound (X1) with a vinylidene-containing compound, e. g. a vinylidene-containing carboxylic acid such as (meth)acrylic acid, crotonic acid, itaconic acid, fumaric acid, maleic acid, acrylamidoglycolic acid and methacrylamidoglycolic acid, and compounds according to compound (B) as defined below.

Compound (X1) is for example selected from at least twice epoxidised vegetable oils.

In one embodiment, a polyurethane having at least two polymerisable vinylidene groups and optionally having one or more urea groups is obtained by reacting an NCO prepolymer (A) with a compound (B) comprising a polymerisable vinylidene group and an NCO reactive group.

The NCO prepolymer (A) may be obtained by reacting at least one polyisocyanate (C), i. e. an at least difunctional isocyanate, with at least one compound (D) comprising at least two NCO-reactive groups. NCO prepolymer means polymers, in particular polyurethanes, which have NCO groups.

The NCO-reactive group in the compound (B) and (D) may each be independently selected from an OH group, an NH₂ group and an SH group.

The NCO-reactive compound (D) may be at least one diol, polyol, polyester polyol, polyether polyol polycarbonate polyol, and/or at least one nucleophilic nitrogen compound (E), preferably a primary or secondary diamine.

In one embodiment, compound (D) may be selected from
diols, such as ethylene glycol, 1,2-propanediol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, neopentyl glycol, hydroxypivalic acid neopentylglycol ester, 2-ethyl-1,3-propanediol, 2-methyl-1,3-propanediol, 2,2-bis(4-hydroxycyclohexyl)propane, 1,1-, 1,2-, 1,3- or 1,4-cyclohexanedimethanol, 1,2-, 1,3- or 1,4-cyclohexanediol,
polyols, such as trimethylolbutane, trimethylolpropane, trimethylolethane, pentaerythritol, glycerol, ditrimethylolpropane, dipentaerythritol, sorbitol, mannitol, diglycerol, threit, erythritol, adonitol (ribitol), arabitol (lyxite), xylitol, dulcitol (galactitol), maltitol or isomaltitol, which may optionally be alkoxylated with the above building blocks. Suitable alkylene oxide building blocks are, for example, derived from ethylene oxide, propylene oxide, iso-butylene oxide, 1-butene oxide, 2-butene oxide, vinyloxirane, styrene oxide or epichlorohydrin.
polyetherdiols which may be built up from alkylene oxide building blocks and are derived, for example, from cyclic precursors such as ethylene oxide, propylene oxide, iso-butylene oxide, 1-butene oxide, 2-butene oxide, vinyloxirane, styrene oxide and epichlorohydrin. Suitable polyether diols may also be composed of several of the above building blocks. Preferred are polyethylene glycol having a molecular weight between 106-2000 g/mol, polypropylene glycol with a molecular weight between 134-2000 g/mol, polytetrahydrofuran with a molecular weight between 162-2000 g/mol, poly-1,3-propanediol with a molecular weight between 134-2000 g/mol, and
polyester polyols, preferably prepared by reaction of diols/polyols with dicarboxylic acids/dianhydrides. Suitable diols/polyols include but are not limited to the above diols, polyols and polyether diols. Suitable dicarboxylic acids are, for example, aliphatic, cycloaliphatic, araliphatic, aromatic or heterocyclic and are optionally substituted with halogens, in particular F, Cl or Br. Suitable dicarboxylic acids are in particular oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid, tetrahydrophthalic acid and cork acid. Suitable dianhydrides are, for example, phthalic acid anhydride, tetrahydrophthalic acid anhydride, hexahydrophthalic acid anhydride, tetrachlorophthalic acid anhydride, endomethylene tetrahydrophthalic acid anhydride, glutaric acid anhydride, maleic acid anhydride and succinic acid anhydride.
polycarbonate polyols, preferably obtained by condensation of diaryl carbonates with diols or polyols or by reaction of diols and polyols with phosgene. Preferred diols/polyols used are bisphenol A, bisphenol S, dihydroxydiphenyl sulfide, tetramethylbisphenol A, 1,1-bis(4-hydroxyphenyl)-3,3,5-trimethylcyclohexane and 1,1,1-tris(4-hydroxyphenyl)ethane. Preferred diaryl carbonates are diphenyl carbonate and ditolyl carbonate or carbonates derived from the other aromatic compounds, such as cresols, chlorophenols, methoxyphenols, alkylphenols and naphthols.

A suitable compound (E) may be selected from hexamethylene diamine, adipic acid dihydrazide 4,4′-methylene dianiline, 4,4′-methylene bis(2-chloroaniline), diphenyl ether 4,4′-diamine and isophorone diamine.

Compound (B) may be selected from hydroxy-, amino-, and/or thiol-functionalised compounds comprising at least one polymerisable vinylidene group. For example, esters or amides of carboxylic acids such as acrylic acid, methacrylic acid, crotonic acid, itaconic acid, fumaric acid and maleic acid, acrylamidoglycolic acid and methacrylamidoglycolic acid are suitable. Suitable esterification agents are the above-mentioned diols or polyols and amino alcohols, such as 2-aminoethanol, 2-(methylamino)ethanol, 3-amino-1-propanol, 1-amino-2-propanol, 2-(2-aminoethoxy)ethanol or 2-mercaptoethanol.

In one embodiment, compound (B) is selected from hydroxyethylene (meth)acrylate, aminoethylene (meth)acrylate, pentaerythritol triacrylate, hydroxypropyl (meth)acrylate, 2-hydroxypropyl (meth)acrylate, 2-hydroxypropyl methacrylamide, acrylic acid 4-hydroxybutyl ester, glycerol di(meth)acrylate, glycerol mono(meth)acrylate, and 3-(acryloyloxy)-2-hydroxypropyl (meth)acrylate.

Compound (C) may be selected from aliphatic, cycloaliphatic or aromatic polyisocyanates such as 2,2′-methylene diphenyl isocyanate, 2,4′-methylene diphenyl isocyanate and 4,4′-methylene diphenyl isocyanate (MDI), polymeric MDI, 2,4-toluylene diisocyanate (TDI), 2,6-toluylene diisocyanate (TDI), triphenylmethane-4,4′,4″-triisocyanate, 2,4,6-triisocyanate toluene, isophorone diisocyanate (IRDI), isophorone diisocyanate trimers, 4,4′-methylenebis-(cyclohexyl isocyanate) (H12MDI), methyl 2,4-cyclohexane diisocyanate, 1,3,5-triisocyanate cyclohexane, 1,3,5-trimethylisocyanate cyclohexane, trimethylene diisocyanate, 1,4,8-triisocyanatoctane, 1,3,6-triisocyanate hexane, tetramethylene diisocyanate, tetramethylene diisocyanate trimers, hexamethylene diisocyanate (HMDI), hexamethylene diisocyanate trimers, xylene diisocyanate (XDI), in particular 1,3- or 1,4-xylene diisocyanate, 2,2,4- or 2,4,4-trimethyl-1,6-hexamethylene diisocyanate, and derivatives thereof, such as biuret-containing and isocyanurate-containing polyisocyanates, and mixtures thereof. In particular, compound (C) is selected from methylene diphenyl isocyanate (MDI), polymeric MDI, toluylene diisocyanate (TDI), isophorone diisocyanate and hexamethylene diisocyanate.

Suitable derivatives of the isocyanates comprise, for example, cyclised oligo- or polyisocyanates. The preparation of cyclised oligo- or polyisocyanates is known to the person skilled in the art and can be carried out according to the known methods of cyclisation according to W. Siefken (Liebigs Annalen der Chemie 562, 1949, pages 75-136), wherein the oligo- or polyisocyanates may be open-chain or cyclic. Suitable derivatives can be obtained from the above di-, tri- and polyisocyanates by linkage using urethane, allophanate, urea, biuret, uretdione, amide, isocyanurate, carbodiimide, uretonimine, oxadiazine trione or iminoxadiazinedione structures.

The NCO prepolymer (A) may have a residual NCO content of 10-50 mol %, preferably 20-40 mol %, based on the original molar amount of NCO groups used. The viscosity of the NCO prepolymer (A) is e. g. 30,000-120,000 mPa·s, preferably 70,000-120,000 mPa·s, measured at 23° C. according to DIN 2555.

The NCO prepolymer (A) for preparing component (i) is preferably used in such an amount that all isocyanate groups react off, i.e. the resulting component (i) is free of NCO groups.

Preferably, component (i) comprises at least one polyurethane having at least two polymerisable vinylidene groups, in particular at least one (cyclo)aliphatic polyurethane having at least two polymerisable vinylidene groups. In a preferred embodiment, component (i) comprises two different aliphatic polyurethanes each having at least two polymerisable vinylidene groups, wherein the mass ratio of the first aliphatic polyurethane to the second aliphatic polyurethane is in the range of, for example, 1:10-10:1, preferably 1:5-5:1, in particular 1:2-2:1.

Suitable polyurethanes may have a weight average molecular weight M_{w} of 2000-50000 g/mol, preferably 4000-20000 g/mol, more preferably 4000-10000 g/mol, wherein the weight average molecular weight M_{w} is determined by gel permeation chromatography using tetrahydrofuran as eluent and polystyrene as standard for calibration at a column temperature of 30° C.

The polyurethanes may optionally also have one or more allophanate, carbodiimide, isocyanurate, biuret, uretdione, urea, iminooxadiazinedione, and/or uretonimine groups.

Component (i) may also comprise a polyallophanate, polycarbodiimide, polyisocyanurate, polybiuret, polyuretdione, polyurea, polyiminooxadiazinedione, and/or polyuretonimine having at least two polymerisable vinylidene groups.

In one embodiment, at least one prepolymer having at least two polymerisable vinylidene groups is obtained by reacting a compound having at least one polymerisable vinylidene group and at least one isocyanate group, such as 2-isocyanatoethyl (meth)acrylate, with a polyol or a polyamine, such as partially deacetylated polyvinylamine. The compound having at least one isocyanate group for preparing component (i) is preferably used in such an amount that all isocyanate groups react off, i. e. the resulting component (i) is free of NCO groups.

In a preferred embodiment, component (i) is free of NCO groups.

In a preferred embodiment, the content of component (i) in the composition is 30-80% by weight, preferably more than 40-80% by weight, preferably more than 40-70% by weight and in particular 45-60% by weight based on the total mass of the composition.

The composition according to the present invention further comprises at least one photoinitiator (component ii). In particular, the composition comprises at least one radical photoinitiator.

Examples of suitable photoinitiators are benzophenones, acetophenones, thioxanthones, α-dicarbonyl compounds, phenylglyoxalic acids, α-hydroxyketones, in particular hydroxyacetophenones, phosphine oxides, such as acylphosphine oxides and bis-acylphosphine oxides, and acylphosphine sulphides and germanium compounds.

Suitable photoinitiators are in particular mono- and bis-acylophosphine oxides, such as 2,4,6-trimethylbenzoyl diphenylphosphine oxide, ethyl-2,4,6-trimethylbenzoylphenyl-phosphinate, and bis-(2,4,6-trimethylbenzoyl)-phenylphosphine oxide, anisoin, benzophenone, hydroxyacetophenone, 2,2-diethoxyacetophenones, 4,4′-dihydroxybenzophenone phenylglyoxylic acid, acetophenone, acetonaphthoquinone, methyl ethyl ketone, valerophenone, hexaphenone, α-phenylbutyrophenone, p-morpholinopropiophenone, dibenzosuberone, 4-morpholinobenzophenone, b-methylanthraquinone, tert-butylanthraquinone, anthraquinone carboxylic acid ester, Benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diiso-propylthioxanthone, 2,4-dichlorothioxanthone, benzoin, benzoin ethyl ether, benzoin isobutyl ether, benzoin isopropyl ether, benzoin methyl ether, benz[de]anthracen-7-one, 1-naphthaldehyde, 4,4′-bis(dimethylamino)benzophenone, 4,4′-bis(diethylamino)benzophenone 4-phenylbenzophenone, 4-chlorobenzophenone, 4-benzoylbiphenyl, camphorquinone 1-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthrene-7,12-dione, 2,2-diethoxyacetophenone, benzil, benzil ketals such as benzildimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraquinone, 2,3-butanedione, (Benzene) tricarbonylchromium, 3,3′,4,4′-benzophenone tetracarboxydianhydride, 2-benzyl-2-(dimethylamino)-4′-morpholinobutyrophenone, 2-chlorothioxanthen-9-one, coumene(cyclopentadienyl)iron (II) hexafluorophosphate, 4,4′dimethylbenzil, 2,5-dimethylbenzophenone, 3,4-dimethylbenzophenone, 4′-ethoxyacetophenone, 2-ethylanthraquinone, ferrocene, 3′-hydroxyacetophenone, 4′-hydroxyacetophenone, 3-hydroxybenzophenone, 4-hydroxybenzophenone, 2-methylbenzophenone, 3-methylbenzophenone, methylbenzoylformate, 2-methyl-4′-(methylthio)-2-morpholinopropiophenone, phenanthrenequinone, 4′-phenoxyacetophenone.

Preferred photoinitiators are benzophenone, 1-hydroxycyclohexylphenyl ketone, 2-hydroxy-2-methylpropiophenone, phenylbis(2,4,6-trimethylbenzoyl)phosphine oxide, 2-hydroxy-1-[4-[4-(2-hydroxy-2-methylpropionyl)benzyl)phenyl)-2-methylpropan-1-one and mixtures thereof.

Some photoinitiators such as benzophenones can be used in combination with photosensitizers that act as photochemical catalysts. Examples of suitable photosensitizers are tertiary amines which are used as hydrogen donors, such as methyl diethanolamine, N,N-dimethylaminobenzoate, 2-(N-methyl-N-phenylamino)-1-phenylethanol, dimethylaminoethyl acrylate, N,N-dimethyl-2-morpholinoethan-1-amine and alkyldimethylamine, wherein the alkyl chain may contain 1 to 20 carbon atoms.

Component (ii) comprises in particular at least one photoinitiator which absorbs in a wavelength range of 100-800 nm, preferably 200-600 nm. In particular, component (ii) comprises at least two photoinitiators that exhibit different absorption maxima in different wavelength ranges, such as in a wavelength range of 250-270 nm and 310-330 nm.

In one embodiment, the composition according to the present invention comprises two photoinitiators, such as an α-hydroxyketone photoinitiator and a phosphine oxide photoinitiator, in particular in a mass ratio of 1:10-10:1, preferably 1:5-5:1, more preferably 1:2-2:1.

The content of component (ii) in the composition is preferably 0.1-15% by weight, more preferably 1-10% by weight and in particular 1-5% by weight based on the total mass of the composition.

The composition according to the present invention further comprises at least one compound having at least one polymerisable vinylidene group (component (iii)), which is different from the at least one prepolymer having at least two polymerisable vinylidene groups of component (i). In a preferred embodiment, component (iii) comprises at least two, preferably 2-5, different compounds having at least one polymerisable vinylidene group, which are different from the at least one prepolymer having at least two polymerisable vinylidene groups of component (i).

The compound having at least one polymerisable vinylidene group comprises one or more polymerisable vinylidene groups, such as one, two, three, four or more, preferably 1-3 polymerisable vinylidene groups. In a preferred embodiment, component (iii) comprises one or more compounds having a polymerisable vinylidene group, in particular 2-5 compounds having a polymerisable vinylidene group. The at least one polymerisable vinylidene group is in particular a (meth)acrylate group.

Component (iii) has a weight average molecular weight of 70-800 g/mol, preferably 100-500 g/mol and more preferably 100-450 g/mol. In a preferred embodiment, all compounds having at least one polymerisable vinylidene group of component (iii) have a weight average molecular weight of 70-800 g/mol, preferably 100-500 g/mol, more preferably 100-450 g/mol.

The viscosity of component (iii) may be 1-2,000 mPa·s and preferably 1-500 mPa·s measured at 23° C. according to DIN 2555. The boiling point of component (iii) may be in a range of, for example, 80-400° C. In one embodiment, component (iii) comprises at least one compound having at least one polymerisable vinylidene group, which has a boiling point of 100-300° C., in particular 200-300° C.

The at least one compound having at least one polymerisable vinylidene group (component (iii)) can be an unsaturated carboxylic acid as well as esters thereof, such as acrylic acid, methacrylic acid, crotonic acid, itaconic acid, fumaric acid, maleic acid, acrylamidoglycolic acid or methacrylamidoglycolic acid, with a C₁-C₂₂ alcohol, such as methanol, ethanol, propanol, iso-propanol, butanol, 2-butanol, pentanol, hexanol, heptanol, octanol, nonanol, decanol, undecanol, dodecanol, tridecanol, tetradecanol, pentadecanol, hexadecanol, heptadecanol, octadecanol, nonandecanol, eicosanol, heneicosanol, docosanol or an ester thereof.

In one embodiment, the at least one compound having at least one polymerisable vinylidene group (component (iii)) may comprise an ester of an unsaturated carboxylic acid, such as acrylic acid, methacrylic acid, crotonic acid, itaconic acid, fumaric acid, maleic acid, acrylamidoglycolic acid or methacrylamidoglycolic acid, with a diol or polyol (for example selected from the diols and polyols listed above).

Further examples of compounds of component (iii) are vinyl ethers or allyl ethers of diols or polyols with 2 to 20 C atoms.

Furthermore, component (iii) may also comprise an amide or thioester of an unsaturated carboxylic acid such as acrylic acid, methacrylic acid, crotonic acid, itaconic acid, fumaric acid, maleic acid, acrylamidoglycolic acid or methacrylamidoglycolic acid, with amines, polyamines, thioalcohols and aminoalcohols, e. g. 2-aminoethanol, 2-(methylamino)ethanol, 3-amino-1-propanol, 1-amino-2-propanol, 2-(2-aminoethoxy)ethanol, or 2-mercaptoethanol, ethylenediamine or diethylenetriamine. In one embodiment, component (iii) particularly comprises (meth)acrylamide, N-methylmethacrylamide, N,N-dimethyl(meth)acrylamide, N,N-diethyl(meth)acrylamide, N-[3-(dimethylamino)propyl](meth)acrylamide, N-iso-propyl(meth)acrylamide, N-iso-propyl(meth)acrylamide, N-tert-butyl(meth)acrylamide, N-(butoxymethyl)(meth)acrylamide, (hydroxymethyl)(meth)acrylamide, N-(2-hydroxyethyl)(meth)acrylamide, 6-(meth)acrylamidohexanoic acid, diacetone(meth)acrylamide, 4-(meth)acryloylmorpholine, 3-(meth)acryloyl-2-oxazolidinone, N-phenyl(meth)acrylamide, N,N-methylenebismethacrylamide or a mixture thereof.

Further examples of compounds of component (iii) are vinyl aromatic compounds, such as styrene, vinyl pyridines, vinyl carbazoles or vinyl acetic acid, acrylonitrile, vinyl pyrrolidones or vinyl halides, such as vinylidene chloride.

In a preferred embodiment, component (iii) comprises at least one (cyclo)aliphatic compound. Preferably, a compound having at least one polymerisable vinylidene group of component (iii) comprises a poly(C₁₋₃ alkoxylene) group and a (meth)acrylate group, such as polyethylene glycol (meth)acrylate or polypropylene glycol (meth)acrylate, in particular polyethylene glycol (meth)acrylate or polypropylene glycol (meth)acrylate having a molecular weight between 70 and 800 g/mol.

In a preferred embodiment, component (iii) comprises (meth)acrylic acid, methyl (meth)acrylate, ethyl (meth)acrylate, propyl (meth)acrylate, iso-propyl (meth)acrylate, n-butyl (meth)acrylate, iso-butyl (meth)acrylate, tert-butyl (meth)acrylate, iso-pentyl(meth)acrylate, hexyl(meth)acrylate, ethylhexyl(meth)acrylate, tert-butylcyclohexyl(meth)acrylate, cyclohexyl(meth)acrylate, stearyl methacrylate, isobornyl(meth)acrylate, dicyclopentanyl(meth)acrylate, 2-phenoxyethyl(meth)acrylate, benzyl(meth)acrylate, tetrahydrofurfuryl (meth)acrylate, furfuryl (meth)acrylate, mevalonlactone (meth)acrylate, hydroxyethyl (meth)acrylate, 2-methoxyethyl (meth)acrylate, 4-hydroxybutyl (meth)acrylate, hydroxypropyl (meth)acrylate, 2-(2-ethoxyethoxy)-ethyl (meth)acrylate, β-carboxyethyl (meth)acrylate, 2-(dimethylamino)ethyl (meth)acrylate, 2-(diethylamino)ethyl (meth)acrylate, 3-chloro-2-hydroxypropyl (meth)acrylate, 2-phenoxyethyl (meth)acrylate, tetramethylene glycol di(meth)acrylate, pentamethylene glycol di(meth)acrylate, hexamethylene glycol di(meth)acrylate, nonamethylene glycol di(meth)acrylate, decamethylene glycol di(meth)acrylate, dipropylene glycol di(meth)acrylate, tripropylene glycol di(meth)acrylate, ethylene glycol di(meth)acrylate, diethylene glycol di(meth)acrylate, triethylene glycol di(meth)acrylate, tetraethylene glycol di(meth)acrylate, 1,3-butylene glycol di(meth)acrylate, dipentaerythritol penta/hexaacrylate, trimethylol propane tri(meth)acrylate, dimethylol propane tetra(meth)acrylate, 5 moles of ethoxylated pentaerythritol tetra(meth)acrylate, hexanediol di(meth)acrylate, glycerol tri(meth)acrylate, glycerol di(meth)acrylate, propoxylated glycerol tri(meth)acrylate, pentaerythritol diacrylate, pentaerythritol triacrylate, pentaerythritol tetraacrylate trimethylolpropane ethoxy triacrylate, neopentyl glycol di(meth)acrylate, neopentyl glycol propoxylate (1 PO/OH)-di(meth)acrylate, bisphenol A di(meth)acrylate, 1,3,5-tri(meth)acryloylhexahydro-1,3,5-triazine, tris(2-acryloyloxyethyl)isocyanurate, polyethylene glycol(meth)acrylate, polypropylene glycol(meth)acrylate or a mixture thereof.

In a preferred embodiment, component (iii) is free of NCO groups.

The content of component (iii) in the composition may be 20-70% by weight, preferably 20 to less than 60% by weight, more preferably 30 to less than 60% by weight, more preferably 30-55% by weight and in particular 40-50% by weight based on the total mass of the composition.

The mass ratio of component (i) to component (iii) in the composition is, for example, 10:1 to 1:10, in particular 5:1 to 1:5.

In one embodiment, the composition according to the present invention comprises
(i) at least one prepolymer having at least two polymerisable vinylidene groups, wherein component (i) preferably has a weight average molecular weight M_{w} of 2000-50000 g/mol, more preferably 4000-10000 g/mol,
(ii) at least one photoinitiator, and
(iii) at least one compound having a polymerisable vinylidene group, wherein component (iii) has a weight average molecular weight M_{w} of 70-800 g/mol, preferably 100-500 g/mol, more preferably 100-450 g/mol.

In a preferred embodiment, the composition according to the invention comprises
(i) at least two prepolymers having at least two polymerisable vinylidene groups, wherein component (i) preferably has a weight average molecular weight M_{w} of 2000-50000 g/mol, more preferably 4000-10000 g/mol,
(ii) at least two photoinitiators, and
(iii) at least one compound having a polymerisable vinylidene group, wherein component (iii) has a weight average molecular weight M_{w} of 70-800 g/mol, preferably 100-500 g/mol, more preferably 100-450 g/mol.

In a preferred embodiment, the composition according to the invention comprises
(i) at least two prepolymers having at least two polymerisable vinylidene groups, wherein component (i) preferably has a weight average molecular weight M_{w} of 2000-50000 g/mol, more preferably 4000-10000 g/mol,
(ii) at least two photoinitiators, and
(iii) at least two compounds having a polymerisable vinylidene group wherein component (iii) has a weight average molecular weight M_{w} of 70-800 g/mol, preferably 100-500 g/mol, more preferably 100-450 g/mol.

In a preferred embodiment, the composition according to the present invention comprises
(i) at least one polyurethane, in particular an aliphatic polyurethane, having at least two polymerisable vinylidene groups and optionally one or more urea groups, wherein component (i) preferably has a weight average molecular weight M_{w} of 2000-50000 g/mol, more preferably 4000-10000 g/mol,
(ii) at least one photoinitiator, and
(iii) at least one compound having a polymerisable vinylidene group, wherein component (iii) has a weight average molecular weight M_{w} of 70-800 g/mol, preferably 100-500 g/mol, more preferably 100-450 g/mol.

In a preferred embodiment, the composition according to the present invention comprises
(i) at least one polyurethane, in particular an aliphatic polyurethane, having at least two polymerisable vinylidene groups and optionally one or more urea groups, component (i) preferably having a weight average molecular weight M_{w} of 2000-50000 g/mol, more preferably 4000-10000 g/mol,
(ii) at least one photoinitiator, and
(iii) at least one compound having a polymerisable vinylidene group which has a weight average molecular weight of 70-800 g/mol.

The composition according to the present invention may further comprise at least one additive. Suitable additives may be, for example, pigments, polymerisation inhibitors, oxygen scavengers, hydrophobing agents, tackifiers, dyes, fragrances, flame retardants, latent heat storage agents, biocides, preservatives or combinations thereof.

Oxygen scavengers are compounds that reduce or prevent polymerisation inhibition in the presence of oxygen. Examples of suitable oxygen scavengers are tertiary amines such as methyl diethanolamine, N,N-dimethylaminobenzoate, 2-(N-methyl-N-phenylamino)-1-phenylethanol, dimethylaminoethylacrylate as well as alkyl dimethylamine, where the alkyl chain may contain 1 to 20 carbon atoms, such as Polycat® 77 and XDM from the company Air Products.

Polymerisation inhibitors are compounds that primarily prevent spontaneous polymerisation and thus increase the storage stability of radically polymerisable substances and mixtures of substances. Suitable polymerisation inhibitors are e. g. phenol, hydroquinone, p-benzoquinone, 4-nitrophenol, 4-methoxyphenol (MEHQ) and 2,6-di-ted-butyl-4-methylphenol and phenothiazine.

Suitable hydrophobing agents are e. g. vinylidene-containing compounds with perfluoroalkyl groups of different chain lengths, such as 2,2,2-trifluoroethyl(meth)acrylate, 1H,2H-pentadecafluoro-n-octyl(meth)acrylate, 2,2,3,3-tetrafluoropropyl (meth)acrylate, 1H,1H,5H-octafluoropentyl (meth)acrylate, perfluoro-C₆-alkyl ethyl (meth)acrylate, perfluoro-C₈-alkyl ethyl (meth)acrylate and 2,2,3,4,4,5,5-octafluorohexamethylene di(meth)acrylate. Similarly, fluorine-free alkyl (meth)acrylates, wherein the alkyl residue is a linear or branched C₈-C₂₂ residue, or silicones or mixtures thereof may be used for hydrophobising.

Furthermore, electrically conductive magnetic metal particles may be contained in the composition according to the present invention.

In order to increase the tackiness and elasticity of the bonded fibre unit, tackifiers such as monofunctional ethylenically unsaturated compounds based on polyalkylene oxide (meth)acrylates can be used as additives.

Further suitable additives that influence the properties of the polymer obtained by the composition according to the present invention with regard to its tackiness are, for example, primary, secondary and tertiary diols such as ethylene glycol, 1,2-propanediol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, neopentyl glycol, hydroxypivalic acid pentyl glycol ester, 2-ethyl-1,3-propanediol, 2-methyl-1,3-propanediol, 2,2-bis(4-hydroxycyclohexyl)propane, 1,1-, 1,2-, 1,3- or 1,4-cyclohexanedimethanol, 1,2-, 1,3- or 1,4-cyclohexanediol, trimethylolbutane, trimethylolpropane, trimethylolethane, neopentylglycol, pentaerythritol, glycerol, ditrimethylolpropane, dipentaerythritol, sorbitol, mannitol, diglycerol, threit, erythritol, adonitol (ribitol), arabitol (lyxite), xylitol, dulcitol (galactitol), maltitol or isomaltitol, which may optionally be alkoxylated, or mixtures thereof.

Suitable flame retardants are, for example, halogenated flame retardants such as tetrabromobisphenol A (TBA), bromopolystyrene, chlorinated paraffins and dibromopentyl glycol (DBNPG). Preferably, phosphate-containing flame retardants, particularly preferably organic phosphoric acid esters or cyclic phosphate derivatives, or mixtures thereof, are used.

Suitable latent heat storage materials may be selected from saturated or unsaturated, linear, branched or cyclic hydrocarbon, preferably saturated or unsaturated, linear, branched or cyclic C₁₀-C₄₀ alkane and C₆-C₂₀ aromatic hydrocarbon, and are in particular selected from n-hexadecane, n-heptadecane, n-octadecane, n-nonadecane, n-eicosane, cyclohexane, n-heptadecane, n-octadecane, n-nonadecane, n-eicosane, cyclooctane, cyclodecane, benzene, nahphthalene, biphenyl, saturated or unsaturated C₆-C₃₀ fatty acids, saturated or unsaturated C₆-C₃₀ fatty alcohol and saturated or unsaturated C₆-C₃₀ fatty acid C₁-C₁₀ alkyl ester, preferably lauric, stearic, oleic or behenic acid, lauryl, stearyl or oleyl alcohol, propyl palmitate, methyl stearate or methyl palmitate, and mixtures.

Biocides, such as pesticides, fungicides, herbicides, insecticides, algicides, molluscicides, acaricides, rodenticides, bactericides, antibiotics, antiseptics, antibacterial, antiviral, antifungal, antiparasitic biocides, or mixtures thereof, may further be used as additives.

The composition according to the present invention may optionally contain preservatives such as isothiazolinones to improve the storage stability of the composition.

Furthermore, polyalkoxylates such as polyethylene glycol with a molecular weight between 106-2000 g/mol, polypropylene glycol with a molecular weight between 134-2000 g/mol, polytetrahydrofuran with a molecular weight between 162-2000 g/mol, or poly-1,3-propanediol with a molecular weight between 134-2000 g/mol as well as mixtures thereof may be used as additives. A special characteristic of these additives is their relatively low volatility with a boiling point of at least 180° C.

In a preferred embodiment, the composition according to the present invention is present in liquid form at room temperature (i. e. 20° C.), for example as solution or dispersion. The viscosity of the composition according to the present invention is, for example, 1,000-10,000 mPa·s, preferably 2,000-7,500 mPa·s and in particular 2,500-4,500 mPa·s measured at 23° C. according to DIN 2555.

Preferably, the composition according to the invention is free of water, i. e. has less than 10% by weight, in particular less than 5% by weight such as 0.001-5% by weight, preferably less than 2% by weight of water with respect to the total weight of the composition.

In one embodiment, the composition according to the present invention is free of organic solvents, in particular organic solvents such as butyl acetate, methoxypropyl acetate, methyl ethyl ketone, primary alcohols, e. g. methanol, ethanol, propanol, iso-propanol, butanol, pentanol, hexanol, carboxylic acid esters, e. g. ethyl acetate, iso-propyl acetate, butyl acetate, methoxypropyl acetate, ketones, e. g. acetone, methyl ethyl ketone, dibutyl ketone, cyclohexanone, ethers, e. g. diethyl ether, ethylene glycol monoethyl ether and tert-butyl methyl ether, alkanes, such as n-pentane, n-hexane, iso-hexane, n-heptane, octane, iso-octane, special petrol, light petrol, petroleum ether, cyclohexane, aromatic hydrocarbons, such as e. g. benzene, toluene, xylene, phenol, nitrobenzene, aniline, methyl benzoate, phenyl acetate, halogenated aliphatic hydrocarbons such as dichloromethane, chloroform, carbon tetrachloride and dimethylformamide, dimethyl sulphoxide, carbon disulphide, nitroalkanes, diethyl phosphate, sulfolane or mixtures thereof. Free of organic solvents means that the composition according to the present invention comprises less than 5% by weight, such as 0.001-5% by weight, preferably less than 2% by weight, more preferably less than 1% by weight of organic solvent based on the total weight of the composition.

In a preferred embodiment, the composition according to the present invention is free of water and free of inert organic solvents such as alcohols, e. g. methanol, ethanol, propanol, iso-propanol, butanol, pentanol, hexanol, carboxylic acid esters, e. g. ethyl acetate, iso-propyl acetate, butyl acetate, methoxypropyl acetate, ketones, e. g. acetone, methyl ethyl ketone, dibutyl ketone, cyclohexanone, ethers, e. g. diethyl ether, ethylene glycol monoethyl ether and tert-butyl methyl ether, alkanes, e. g. n-pentane, n-hexane, iso-hexane, n-heptane, octane, iso-octane, special petrol, light petrol, petroleum ether, cyclohexane, aromatic hydrocarbons such as benzene, toluene, xylene, phenol, nitrobenzene, aniline, methyl benzoate, phenyl acetate, halogenated aliphatic hydrocarbons such as dichloromethane, methane and methyl benzoate. e. g. dichloromethane, chloroform, carbon tetrachloride and dimethylformamide, dimethyl sulphoxide, carbon disulphide, nitroalkanes, diethyl phosphate, sulfolane or mixtures thereof.

By means of the composition according to the present invention filaments, yarns, such as fancy yarns, simple yarns, textured yarns, multiple wound yarns, spun yarns, rotor yarns, tricylinder yarns, worsted yarns, semi-worsted yarns, carded yarns, schappe yarns, bourette yarns, filament yarns, such as multifilament yarns and monofilament yarns, twines, such as fancy twines, single-stage twines, multi-stage twines and covering twines, continuous twines, ropes, fibres such as staple fibres and fibre bundles, and filament silk made of natural material, semi-synthetic material, synthetic material or a mixture thereof can be bonded.

After bonding, the fibre unit should remain flexible and have a uniform surface. Untwisting and splitting due to mechanical stress should be avoided. The quantitative application of polymer is preferably between 1 and 30%, in particular between 1 and 20% of the weight of the yarn.

In a further aspect, the present invention relates to a polymer obtainable by polymerising, in particular photopolymerising, the composition according to the present invention. Photopolymerisation involves irradiation with electromagnetic radiation, preferably UV light in a wavelength range from 100 to 800 nm, as described in the following. The radiation dose usually used for polymerisation is in the range of 80-3000 mJ/cm².

The polymer according to the present invention preferably has a Shore A hardness of 50-150 measured according to DIN 53505. The pendulum hardness of the polymer according to the present invention is preferably 5-20 seconds measured according to DIN 53157.

The elongation at break of the polymer according to the present invention is in particular 10-1000%, preferably 10-500%, measured according to DIN 53504.

In a further aspect, the present invention relates to the use of the composition according to the present invention for bonding of a fibre unit such as a yarn, such as fancy yarns, simple yarns, textured yarns, multiple wound yarns, spun yarns, rotor yarns, tricylinder yarns, worsted yarns, semi-worsted yarns, carded yarns, schappe yarns, bourette yarns, filament yarns, such as multifilament yarns and monofilament yarns, of a twine, such as fancy twines, single stage twines, multi stage twines and covering twines, continuous twines, of a rope, fibres such as staple fibres and fibre bundles, and filament silk made of natural material, semi-synthetic material, synthetic material or a mixture thereof.

In another aspect, the present invention relates to a method of bonding fibre units comprising the steps of:
(a) providing a composition according to the present invention as described herein,
(b) applying the composition provided in step (a) to at least one fibre unit, and
(c) irradiating the fibre unit obtained in step (b) with radiation of a wavelength in the range of e. g. 100-800 nm, preferably 100-450 nm.

Suitable fibre units that can be used in step (b) have already been described above.

In one embodiment, the fibre unit in step (b) is passed through an immersion bath, which contains the composition according to the present invention. In another embodiment, the composition according to the present invention is applied to the fibre unit in step (b) via a godet that is at least partially immersed in a godet bath. Optionally, the temperature of the immersion or godet bath can be controlled, for example in order to control the viscosity of the composition according to the present invention to make it suitable for the respective application method. In particular, parameters such as the uptake amount and the penetration depth of the composition into the fibre unit are dependent from the viscosity of the composition according to the present invention.

After step (b), the composition according to the present invention can optionally be uniformly distributed on and in the fibre unit, for example by squeezing or stripping off the composition according to the present invention between rollers, squeeze rollers, rolls, non-woven material or other squeezing or stripping devices which are known to the person skilled in the art. In this way, a uniform distribution of the composition according to the present invention in the longitudinal and/or cross section of the fibre unit can be achieved.

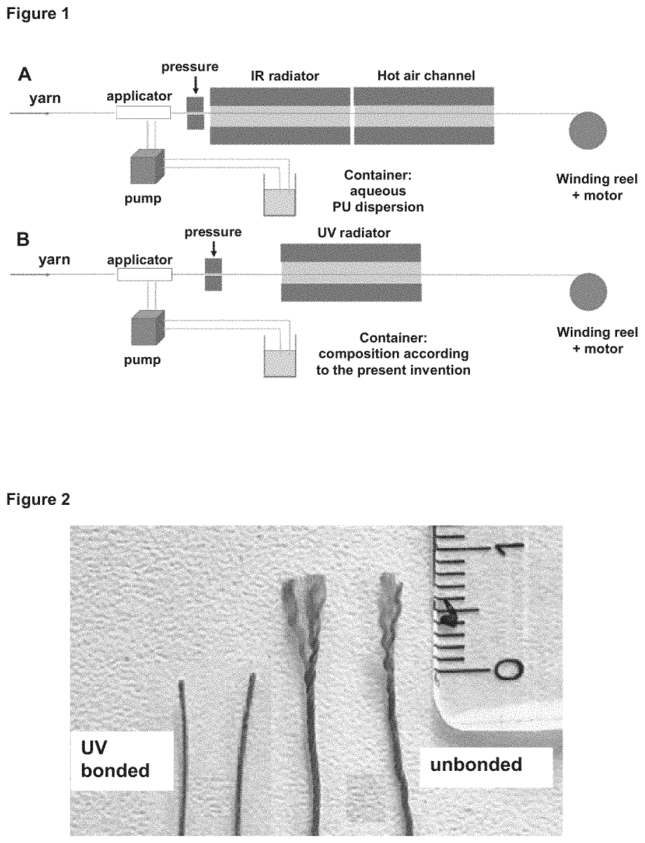

In one embodiment, the composition according to the present invention is applied to the fibre unit by means of a dosing system, in particular by means of a sponge applicator (FIG. 1B). Thereby, the composition according to the present invention is continuously fed to the sponge and from there evenly applied to the fibre unit. In the dosing system, the fibre unit first passes through an application area and then through a subsequent uniformisation area in the conveying direction, in which, for example, a uniform distribution of the composition according to the present invention in the longitudinal and/or cross section of the fibre unit is achieved by squeezing or stripping the composition according to the present invention between rollers, squeeze rollers, rolls, non-woven material or other squeezing or stripping devices which are known to the person skilled in the art.

The uptake amount of the composition according to the present invention in step (b) is in the range of, for example, 1-40, preferably 3-30, particularly preferably 5-20% by weight based on the weight of the fibre unit. The speed at which the composition according to the present invention is applied to the fibre unit in step (b) is in a range of e. g. 2-150 m/s.

In step (c), the fibre unit obtained in step (b) is irradiated, which initiates polymerisation of the composition according to the present invention.

Suitable radiation sources are in particular conventional lamps which preferably emit light in the wavelength range from 100 to 800 nm, preferably in the range from 200 nm to 500 nm and further preferably in the range from 240 nm to 400 nm, e. g. excimer lamps, pulsed emitters, lasers, LED lamps and high-pressure mercury emitters. In a preferred embodiment, the irradiation is performed with a power of 100-500 W/cm. The radiation dose usually used for cross-linking is in the range of 80-3000 mJ/cm².

In a preferred embodiment, the irradiation is carried out with the aid of an air-cooled UV high-pressure lamp (e.g. Jetcure 420) with a power of 200 W/cm2 and a dichroic reflector.

The irradiation time of a fibre unit section in step (c) is in particular in a range of 0.1-300 s, preferably 0.1-100 s, in particular 1-10 s. The distance between the fibre unit and the radiation source is in particular 0.2 to 20 cm.

Step (c) may be carried out in the presence of air. In another embodiment, step (c) is carried out in an inert atmosphere, since in this case a higher reactivity and consequently a faster and more complete polymerisation can be achieved. Steps (b) and/or (c) may also be carried out under inert atmosphere.

The fibre unit obtained according to step (c) may further be provided with a special preparation or finish, a so-called avivage, which can adapt or improve the processing properties such as sewing properties of the fibre unit. Such an avivage can be used, for example, to control the slip properties, the abrasion resistance and/or the static charge of the fibre unit.

The application of the avivage can be carried out, for example, via a rewinding process, whereby the avivage is applied with a gallette or a dosing system having an applicator. The avivage may comprise, for example, silicones, paraffins, waxes, emulsifiers and/or antistatics.

In a preferred embodiment, the method according to the present invention is a continuous method.

In another aspect, the present invention relates to a fibre unit which is obtained by a method according to the present invention as described herein. The polymerised bonding composition has a high flexibility and elasticity and exhibits high tensile strength, such that the fibre unit bonded according to the present invention retains its original mechanical properties. Likewise, the polymerised bonding composition is not tacky, so that undesirable sticking together of the fibre unit in the coiled state is prevented.

In particular, the fibre unit forms a compact unit consisting of its individual fibres by the bonding according to the invention, which remains intact under high mechanical stress, such as that prevailing in a sewing process. This characteristic is shown, for example, in the cutting test, in which the fibre unit is cut with commercially available scissors. In the case of an unbonded yarn, spreading of the individual fibres can be observed after cutting (see FIG. 2, right), whereas the yarn bonded according to the present invention (see FIG. 2, left) remains a compact unit which does not show spreading of the individual fibres. Spreading, as observed with an unbonded fibre, makes it difficult to rethread during the sewing process, for example.

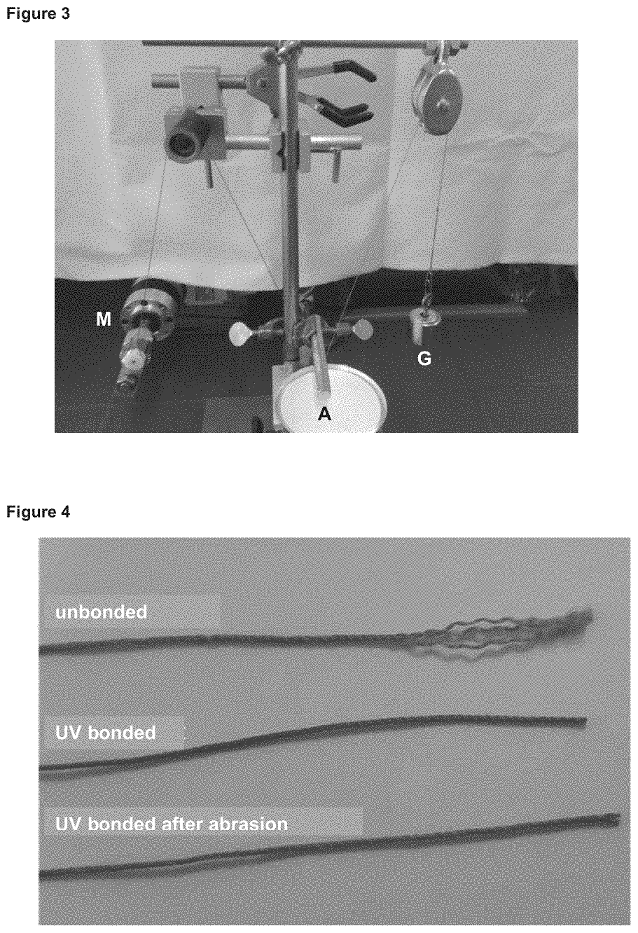

Even after abrasion of the yarn (e. g. in an abrasion device as shown in FIG. 3), the cut fibre unit remains bonded and forms a compact unit without spreading of the individual fibres (cf. FIG. 4). Rethreading, for example after a fibre break during sewing, is thus ensured by the composition according to the invention.

Furthermore, the fibre unit according to the present invention has a strongly reduced absorption capacity towards water. For example, absorption tests, water droplets sank into a yarn according to the present invention within 175 s, whereas the corresponding unbonded yarn had a sinking time of 4 s. Also in the wicking test according to DIN 53924 it was shown that a fibre unit bonded according to the invention with a coating of 12% bonding composition reached a rising height of 10 cm only after 13 min, for example, whereas the corresponding unbonded fibre unit showed the same stand height within 15 s. A reduced water absorption capacity is particularly advantageous, since an otherwise necessary additional hydrophobic finish of the fibre is not required.

Furthermore, the fibre unit according to the present invention is characterised by sufficient antistatic properties. In particular, the fibre unit according to the present invention exhibits comparable antistatic properties to the corresponding unbonded fibre unit. In one embodiment, a fibre unit bonded according to the present invention has a conductivity voltage of 3572 V, whereas the corresponding unbonded yarn has a value of 3603 V, measured by means of a Honigmann surface voltmeter SVM 217E.

Furthermore, the fibre unit bonded according to the present invention is free of cratering after the application and irradiation of the bonding composition. Yarns bonded according to the prior art, for example with an aqueous PU dispersion, show distinct polymer particles on the surface of the yarn (cf. yarn in FIG. 6 right). Such polymer particles are formed in particular when the solvent (e. g. water) evaporates, which causes the polymer film formed on the yarn surface to burst and the particles that are typical of cratering to form. In contrast, a fibre unit according to the present invention does not show any cratering, as can be seen, for example, in the yarn bonded according to the present invention in FIG. 6 on the left, which does not have any polymer particles (cratering).

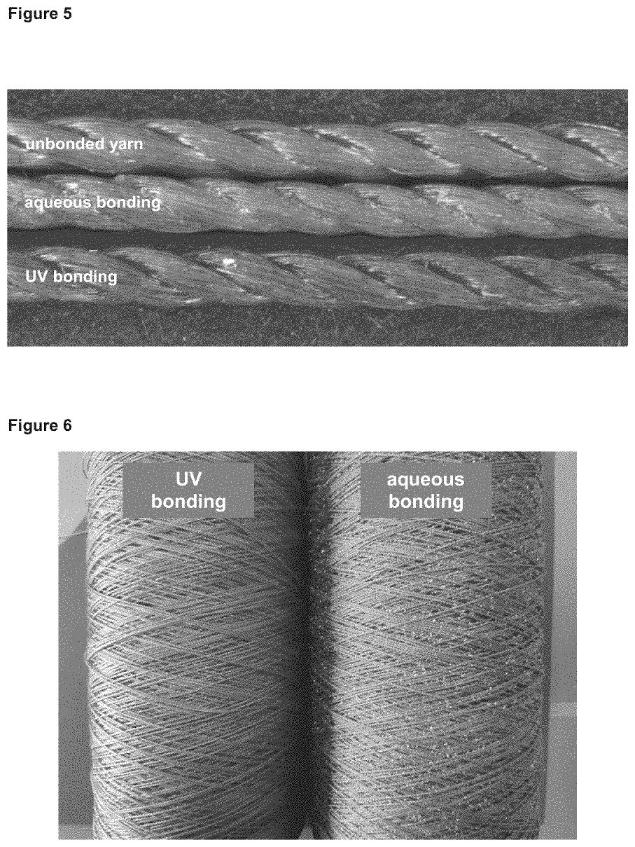

Furthermore, the fibre unit bonded according to the present invention has a uniform distribution of the bonding composition along its cross-section, whereas bonding compositions according to the prior art are located increasingly on the surface of the fibre unit with the amount of coating being the same. In FIG. 5, it can be seen that a yarn bonded by the use of an aqueous PU dispersion has a distinct film on the surface of the yarn. This “film effect” is due to the fact that the water transports the polymer to the surface of the yarn during drying. Thus, less polymer remains inside the yarn to ensure a sufficient bonding effect. In contrast, a fibre unit according to the present invention retains its original yarn structure and film formation does not occur even with a significantly increased amount of applied bonding composition (fibre unit according to the present invention: 23%; aqueous bonded yarn: 12%).

In a preferred embodiment, the present invention relates to the use of the fibre unit bonded according to the present invention for processing textiles in general. In particular, the bonded fibre unit can be used for sewing shoes, outdoor clothing, jackets and coats, curtains, awnings, draperies, bags, backpacks, airbags, seat covers, belts, boot covers, nets, headrests, armrests, centre consoles, generally interiors and fittings in the automotive sector, convertible tops, insulation, carpets, floor mats, fitted carpets, carpets, sailcloth, boat covers, tarpaulins for vehicles and garden furniture, tarpaulins used in agriculture, tarpaulins used outdoors, awnings and tent fabrics, fishing nets.

### EXAMPLES

The present invention will be explained in more detail with reference to the following examples, although the invention is not limited to these examples.

The physical properties listed are taken from the manufacturers specifications. The measurement methods used are indicated where available.

Ebecryl 205 is a radiation curable aromatic polyurethane acrylate dissolved in TPGDA at 30,000 mPa·s at 25° C.

Ebecryl 4740 is a radiation-curable, aliphatic polyurethane acrylate with 8000 mPa·s at 23° C.

Ebecryl 884 is a radiation-curable polyester acrylate with a theoretical molecular weight of 1250 and a viscosity of 25,000 mPa·s at 25° C.

Desmophen 1700 (SL) is a linear polyester polyol containing hydroxyl groups with a hydroxyl content of 1.3±0.09% according to DIN EN ISO 4629-2.

Desmodur I, also known as isophorone diisocyanate, is a bifunctional aliphatic cyclic isocyanate with an NCO content of 37.5% by weight.

Baxxodur EC 201 also known as isophorone diamine is an aliphatic cyclic diamine with an amine number of 660±10 mg KOH/g according to CTP-TS 31-97.

### Embodiment 1 According to the Present Invention

TABLE 1

| | | Proportion in |
|---|---|---|
| Component | Example | [% by weight] |
| Polyurethane acrylate (i) | Ebecryl 205 | 30 |
| Polyurethane acrylate (i) | Ebecryl 4740 | 30 |
| (iii) | tert-butyl methacylate | 34 |
| Photoinitiator (ii) | 1-Hydroxyethylcyclohexyl- | 3.0 |
| | phenylketone | |
| Photoinitiator (ii) | Benzophenone | 3.0 |

The individual components of the composition were mixed in the parts by weight indicated in Table 1 with stirring at room temperature. 16 g of the mixture was poured into a rectangular Teflon mould (width: 14.5 cm, length: 19.5 cm) to obtain a uniform film. The composition was irradiated with a mercury vapour lamp (jetcure) at 100% power at a distance of 6 cm from the emitter source for 3 s. The film obtained was released from the mould and irradiated again on the reverse side in accordance with the above parameters. A flexible film with an average film thickness of 0.67±0.14 mm was obtained. The film had the following properties:

Shore A hardness 86.70±4.180 (21° C.) measured according to DIN 53505.

Pendulum hardness: 27.30 s (21° C.) according to Konig measured according to DIN 53157

Elongation at break: 6.960±2.020% (21° C.) measured according to DIN 53504

### Embodiment 2 According to the Present Invention

TABLE 2

| | | Proportion in |
|---|---|---|
| Component | Example | [% by weight] |
| polyurethane acrylate (i) | Ebecryl 205 | 24.5 |
| polyurethane acrylate (i) | Ebecryl 4740 | 9.00 |
| polyester acrylate (i) | Ebecryl 884 | 33.5 |
| (iii) | tert-butyl methacylate | 28.0 |
| photoinitiator (ii) | 1-Hydroxyethyl cyclohexyl | 2.50 |
| | phenylketone | |
| photoinitiator (ii) | benzophenone | 2.50 |

The individual components of the composition were mixed in the parts by weight indicated in Table 2 with stirring at room temperature. 16 g of the mixture was poured into a rectangular Teflon mould (width: 14.5 cm, length: 19.5 cm) to obtain a uniform film. The composition was irradiated with a mercury vapour lamp (Jetcure) at 100% power at a distance of 6 cm from the emitter source for 3 s. The film was released from the mould and irradiated again on the reverse side according to the above parameters. A flexible film with a thickness of 0.62±0.14 mm was obtained. The film had the following properties:

Shore A hardness: 87.30±2.43 (21° C.) measured according to DIN 53505.

Pendulum hardness: 20.33 s (21° C.) according to Konig measured according to DIN 53157

Elongation at break: 15.53±3.87% (21° C.) measured according to DIN 53504

### Embodiment 3 According to the Invention

TABLE 3

| Chemical | Proportion in [% by weight] |
|---|---|
| Desmophen 1700 (SL) | 40.88 |
| 1,4-diazabicyclo[2.2.2]octane | 0.1100 |
| Iso-propylacetate | 50.57 |
| Desmodur I | 5.840 |
| hydroxyethyl methacrylate | 2.150 |
| Baxxocodur EC 201 | 0.4500 |
| hydroxyethyl methacrylate | 50.57 |

Desmophen 1700 was dissolved in iso-propyl acetate in a three-neck flask with KPG stirrer and reflux condenser. 1,4-Diazabicyclo[2.2.2]octane was added. The solution was heated to 60° C. and Desmodur I was added. The solution was heated to 85° C. and stirred for 4 h. After NCO control (0.94% by weight), Baxxodur EC 201 was added and stirred for a further 2 h. After further NCO control (0.69% by weight), hydroxyethyl methacrylate was added and stirred for 20 h. The reaction solution was cooled down to room temperature and hydroxyethyl methacrylate was added. The volatile components were removed in vacuo and a yellowish liquid with a solids content of 49.57% was obtained. The components were used in the proportions shown in Table 3.

The dry substance was measured with the HX 204 Moisture Analyser from Mettler Tolledo. The measurement was carried out with a drying temperature of 105° C., and a shut-off criterion of 1 mg/50 s with a starting weight of at least 2 g.

The obtained composition was mixed with 1-hydroxyethylcyclohexylphenylketone (2.5% by weight) and benzophenone (2.5% by weight). 32 g of this mixture was poured into a rectangular Teflon mould (width: 14.5 cm, length: 19.5 cm) to obtain a uniform film. The composition was irradiated with a mercury vapour lamp (Jetcure) at 100% power at a distance of 6 cm from the emitter source for 8 s. The film was released from the mould and the emitter was removed. The film was released from the mould and irradiated again on the reverse side according to the above parameters. A flexible film with a thickness of 1.37±0.36 mm was obtained. The film had the following properties:

Shore A hardness: 86.70±4.180 (21° C.) measured according to DIN 53505.

Pendulum hardness: 16.70 s (21° C.) (according to Konig) measured according to DIN 53157

Elongation at break: 125.0±20.00% (21° C.) measured according to DIN 53504

### Embodiment 4 According to the Present Invention

A yarn to be bonded was conveyed with the aid of a motorised spooling unit (20 m/min) through an application set-up including applicator, squeeze roll and irradiation zone as shown in FIG. 1B. By means of a peristaltic squeeze pump, the composition according to embodiment example 3 was conveyed from a storage container into the applicator (pump rate 6 g/min). The applicator contains a chamber filled with a sponge, which was filled with the composition according to the present invention. The yarn passed through the chamber and the sponge provided an even distribution of the composition on the yarn. After passing through the applicator, the yarn was squeezed with the help of a squeeze roller. After passing through the squeeze roller, the yarn passed through the irradiation zone, comprising an air-cooled mercury vapour lamp with a power of 200 W/cm². The distance between yarn and light source was 4 cm, wherein the motorised winding unit conveyed the yarn through the unit at a speed of 10 m/min. After irradiation, the yarn was wound onto the winding reel. The overlay of the yarn thus obtained was 18%.

FIG. 2 shows the cut ends of an unbonded yarn compared to a bonded yarn according to embodiment 4. It can be clearly seen that the bonded yarn is present as a unit after cutting, whereas the filaments of the unbonded yarn untwist.

Abrasion Test:

In the current sewing process, it is necessary to thread the yarn easily and quickly after rupture. For this reason, the yarn should remain bonded despite the mechanical stress, i. e. it should be present as a compact unit. In order to simulate these conditions and to examine the bonding properties of the yarn in the stressed state, the yarn was subjected to an abrasion test.

The test set-up is shown in FIG. 3. The yarn was pulled over an abrasive metal surface A by means of a motor unit M (50 rpm), whereby a load weight (G) of 150 g was used. After the test was performed for 2 min, the yarn was cut in the stressed area in order to check whether the bonding after stress holds the individual filaments together. FIG. 4 shows the results. It can be seen that an unbonded yarn shows a strong untwisting (upper yarn). The yarn according to the present invention, which was subjected to a 2-minute abrasion test (bottom), does not show untwisting of the cut ends. This proves that the bonding according to the present invention is maintained even under the mechanical stress of the sewing process and that a simple rethreading of the yarn, for example, after a tear is possible.

### Comparative Example 1

40 g Beetafin (TS=40%) were poured into a rectangular mould (width: 14.5 cm, length: 19.5 cm). The material was dried at room temperature for 3 days. Afterwards, a film was released from the mould and drying was continued in a drying oven at temperatures of 50° C., 70° C. and 90° C. for 3 h each. Finally, the film was dried at a temperature of 160° C. for 3 min. A flexible film with an average thickness of 0.60±0.06 mm was obtained. The film had the following properties:

Shore A hardness: 79.50±1.910 (21° C.) according to DIN 53505.

Pendulum hardness: 6.650 s (21° C.) (according to Konig) according to DIN 53157

Elongation at break: 1172±40.79% (21° C.) according to DIN 53504

The following items are comprised by the present invention:

1. A composition comprising:
(i) at least one prepolymer having at least two polymerisable vinylidene groups,
(ii) at least one photoinitiator, and
(iii) at least one compound having at least one polymerisable vinylidene group,
wherein component (iii) has a weight average molecular weight M_{w} of 70-800 g/mol, preferably 100-500 g/mol, more preferably 100-450 g/mol.

2. The composition according to item 1, wherein the composition comprises at least 2, preferably 2-5, in particular 2 prepolymers having at least two polymerisable vinylidene groups.

3. The composition according to any one of the preceding items, wherein the polymerisable vinylidene group in the components (i) and (iii) is each independently selected from a (meth)acrylate group, vinyl group and allyl group, in particular from a (meth)acrylic acid ester group and (meth)acrylic acid amide group such as a crotonic acid, itaconic acid, fumaric acid, maleic acid, acrylamidoglycolic acid and methacrylamidoglycolic acid ester or amide group.

4. The composition according to any one of the preceding items, wherein component (i) has a weight average molecular weight M_{w} of 2000-50000 g/mol, preferably 4000-10000 g/mol.

5. The composition according to one of the preceding items, wherein component (i) has a viscosity of 100-120,000 mPa·s, preferably 1,000-100,000 mPa·s and in particular 10,000-70,000 mPa·s measured at 60° C. according to DIN 2555.

6. The composition according to any one of the preceding items, wherein at least one prepolymer having at least two polymerisable vinylidene groups is obtained by reaction of an NCO prepolymer (A) with a compound (B) comprising a polymerisable vinylidene group and an NCO-reactive group.

7. The composition according to item 6, wherein compound (B) is selected from hydroxyethylene (meth)acrylate, aminoethylene (meth)acrylate, an acrylic acid ester, methacrylic acid ester, crotonic acid ester, itaconic acid ester, fumaric acid ester, maleic acid ester, acrylamidoglycolic acid ester or methacrylamidoglycolic acid ester of a diol such as an ethylene glycol, 1,2-propanediol, 2,2-dimethyl-1,2-thanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, neopentylglycol-, hydroxypivalic acid-opentylglycol ester-, 2-ethyl-1,3-propanediol-, 2-methyl-1,3-propanediol-, 2,2-bis(4-hydroxycyclohexyl)propane-, 1,1-, 1,2-, 1,3- or 1,4-cyclohexanedimethanol, 1,2-, 1,3- or 1,4-cyclohexanediol ester, a polyol such as a trimethylolbutane, trimethylolpropane, trimethylolethane, pentaerythritol, glycerol, ditrimethylolpropane, dipentaerythritol, sorbitol, mannitol, diglycerol, threit, erythritol, adonitol (ribitol), arabitol (lyxite), xylitol, dulcitol (galactitol), maltitol or isomaltitol esters, an amino alcohol such as a 2-aminoethanol, 2-(methylamino)ethanol, 3-amino-1-propanol, 1-amino-2-propanol, 2-(2-aminoethoxy)ethanol or 2-mercaptoethanol ester, an acrylic acid, methacrylic acid, crotonic acid, itaconic acid, fumaric acid, maleic acid, acrylamidoglycolic acid or methacrylamidoglycolic acid amide and mixtures thereof.

8. The composition according to any one of items 6-7, wherein the NCO prepolymer (A) has a residual NCO content of 10-50 mol %, preferably 20-40 mol %, based on the molar amount of NCO originally used.

9. The composition according to any one of items 6-8, wherein the NCO prepolymer (A) has a viscosity of 30,000-120,000 mPa·s, preferably 70,000-100,000 mPa·s measured at 23° C. according to DIN 2555.

10. The composition according to any one of items 6-9, wherein the NCO prepolymer (A) is obtained by reaction of at least one polyisocyanate (C), in particular a (cyclo)aliphatic polyisocyanate, with at least one compound (D) comprising at least two NCO-reactive groups.

11. The composition according to any one of items 6-10, wherein the polyisocyanate (C) is selected from aliphatic, cycloaliphatic or aromatic polyisocyanates, such as 2,2′-methylene diphenyl isocyanate, 2,4′-methylene diphenyl isocyanate, and 4,4′-methylene diphenyl isocyanate (MDI), polymeric MDI, 2,4-toluylene diisocyanate (TDI), 2,6-toluylene diisocyanate (TDI), triphenylmethane-4,4′,4″-triisocyanate, 2,4,6-triisocyanate toluene, isophorone diisocyanate (IPDI), isophorone diisocyanate trimers, 4,4′-methylenebis-(cyclohexyl isocyanate) (H12MDI), methyl 2,4-cyclohexane diisocyanate, 1,3,5-triisocyanate cyclohexane, 1,3,5-trimethylisocyanate cyclohexane, trimethylene diisocyanate, 1,4,8-triisocyanatoctane, 1,3,6-triisocyanate hexane, tetramethylene diisocyanate, tetramethylene diisocyanate trimers, hexamethylene diisocyanate (HMDI), hexamethylene diisocyanate trimers, xylene diisocyanate (XDI), 2,2,4- or 2,4,4-trimethyl-1,6-hexamethylene diisocyanate, derivatives thereof and mixtures thereof, in particular of methylene diphenyl isocyanate (MDI), polymeric MDI, toluylene diisocyanate (TDI), isophorone diisocyanate and hexamethylene diisocyanate.

12. The composition according to any one of items 6-11, wherein the NCO-reactive group of compound (B) and (D) is independently selected from each of a hydroxy group, an amino group and a thiol group.

13. The composition according to any one of items 6-12, wherein compound (D) is selected from a polyol, in particular a polyester polyol, polycarbonate polyol or a polyether polyol, a primary or secondary diamine such as hexamethylene diamine, adipic acid dihydrazide, 4,4′-methylene dianiline, 4,4′-methylene bis(2-chloroaniline), diphenyl ether 4,4′-diamine, or isophorone diamine, and mixtures thereof.

14. The composition according to any one of the preceding items, wherein at least one prepolymer having at least two polymerisable vinylidene groups is obtained by reaction of a polyol compound, such as a polyester polyol, polycarbonate polyol or polyether polyol, or a polyepoxidised compound (X1) with a (meth)acrylate, such as acrylic acid, methacrylic acid, crotonic acid, itaconic acid, fumaric acid, maleic acid, acrylamidoglycolic acid and methacrylamidoglycolic acid.

15. The composition according to one of the preceding items, wherein component (i) is a polyurethane, a polycarbonate, a polyether, a polyester, a functionalised vegetable oil or a functionalised sugar polymer, in particular a (cyclo)aliphatic polyurethane optionally with one or more urea groups, with at least two polymerisable vinylidene groups, in particular at least two (meth)acrylate groups, or a mixture thereof.

16. The composition according to one of the preceding items, wherein the content of component (i) in the composition is 30-80% by weight, in particular more than 40-80 by weight, preferably more than 40-70% by weight and in particular 45-60% by weight, based on the total mass of the composition.

17. The composition according to any one of the preceding items, wherein the photoinitiator is a radical photoinitiator, in particular selected from benzophenones, acetophenones, in particular hydroxyacetophenones, thioxanthones, α-dicarbonyl compounds, phenylglyoxalic acids, α-hydroxyketones, phosphine oxides, such as acylphosphine oxide and bis-acylphosphine oxide, acylphosphine sulphides and germanium compounds, or a mixture thereof.

18. The composition according to any one of the preceding items, wherein the photoinitiator is selected from mono- and bis-acylophosphine oxides, such as 2,4,6-trimethylbenzoyl diphenylphosphine oxide, ethyl 2,4,6-trimethylbenzoyl phenyl phosphinate, and bis-(2,4,6-trimethylbenzoyl) phenylphosphine oxide, anisoin, benzophenone, hydroxyacetophenone, 2,2-diethoxyacetophenones, 4,4′-dihydroxybenzophenone phenylglyoxylic acid, acetophenone, acetonaphthoquinone, methyl ethyl ketone, valerophenone, hexaphenone, α-phenylbutyrophenone, p-morpholinopropiophenone, dibenzosuberone, 4-morpholinobenzophenone, b-methylanthraquinone, tert-butylanthraquinone, anthraquinone carboxylic acid ester, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diiso-propylthioxanthone, 2,4-dichlorothioxanthone, benzoin, benzoin ethyl ether, benzoin isobutyl ether, benzoin isopropyl ether, benzoin methyl ether, benz[de]anthracen-7-one, 1-naphthaldehyde, 4,4′-bis(dimethylamino)benzophenone, 4,4′-bis(diethylamino)benzophenone 4-phenylbenzophenone, 4-chlorobenzophenone, 4-benzoylbiphenyl, camphorquinone 1-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, Benz[a]anthrene-7,12-dione, 2,2-diethoxyacetophenone, benzil, benzil ketals such as benzildimethyl ketal, 2-methyl-1-[4-(methylthio)phenyl]-2-morpholinopropan-1-one, Anthraquinones such as 2-methylanthraquinone, 2-ethylanthraquinone, 2-tert-butylanthraquinone, 1-chloroanthraquinone, 2,3-butanedione, (benzenes) tricarbonylchromium, 3,3′,4,4′-benzophenone tetracarboxydianhydride, 2-benzyl-2-(dimethylamino)-4′-morpholinobutyrophenone, 2-chlorothioxanthen-9-one, coumene(cyclopentadienyl)iron (II) hexafluorophosphate, 4,4′-dimethylbenzil, 2,5-dimethylbenzophenone, 3,4-dimethylbenzophenone, 4′-ethoxyacetophenone, 2-ethylanthraquinone, ferrocene, 3′-hydroxyacetophenone, 4′-hydroxyacetophenone, 3-hydroxybenzophenone, 4-hydroxybenzophenone, 2-methylbenzophenone, 3-methylbenzophenone, methylbenzoylformate, 2-methyl-4′-(methylthio)-2-morpholinopropiophenone, phenanthrenequinone, 4′-phenoxyacetophenone, germanium photoinitiators, and mixtures thereof, preferably benzophenone, 1-hydroxycyclohexyl-phenyl ketone, 2-hydroxy-2-methylpropiophenone, phenylbis(2,4,6-trimethylbenzoyl)phosphine oxide, 2-hydroxy-1-[4-[4-(2-hydroxy-2-methylpropionyl)benzyl)phenyl)-2-methylpropan-1-one, and mixtures thereof.

19. The composition according to any one of the preceding items, wherein the content of component (ii) in the composition is 0.1-15% by weight, preferably 1-10% by weight and in particular 1-5% by weight, based on the total mass of the composition.

20. The composition according to any one of the preceding items, wherein component (iii) has a viscosity of 1-2,000 mPa·s and preferably 1-500 mPa·s measured at 23° C. according to DIN 2555.

21. The composition according to any one of the preceding items, wherein component (iii) comprises at least 2, preferably 2-5 compounds having at least one polymerisable vinylidene group.

22. The composition according to any one of the preceding items, wherein at least one compound having at least one polymerisable vinylidene group of component (iii) comprises a poly(C₁₋₃-alkoxylene) group and preferably a (meth)acrylate group and is in particular polyethylene glycol (meth)acrylate or polypropylene glycol (meth)acrylate.

23. The composition according to any one of the preceding items, wherein at least one compound having at least one polymerisable vinylidene group of component (iii) is selected from (meth)acrylic acid, methyl (meth)acrylate, ethyl (meth)acrylate, propyl (meth)acrylate, iso-propyl (meth)acrylate, n-butyl (meth)acrylate, iso-butyl (meth)acrylate, tert-butyl (meth)acrylate, iso-pentyl (meth)acrylate, hexyl (meth)acrylate, ethylhexyl (meth)acrylate, tert-butylcyclohexyl (meth)acrylate, cyclohexyl (meth)acrylate, stearyl methacrylate, isobornyl (meth)acrylate, dicyclopentanyl(meth)acrylate, 2-phenoxyethyl(meth)acrylate, benzyl(meth)acrylate, tetrahydrofurfuryl(meth)acrylate, furfuryl(meth)acrylate, mevalonlactone(meth)acrylate, hydroxyethyl(meth)acrylate, 2-methoxyethyl(meth)acrylate, 4-hydroxybutyl(eth)acrylate, hydroxpropyl (meth)acrylate, 2-(2-ethoxyethoxy)ethyl (meth)acrylate, β-carboxyethyl (meth)acrylate, 2-(dimethylamino)ethyl (meth)acrylate, 2-(diethylamino)ethyl (meth)acrylate, 3-chloro-2-hydroxypropyl (meth)acrylate, 2-phenoxyethyl (meth)acrylate, tetramethylene glycol di(meth)acrylate, pentamethylene glycol di(meth)acrylate, hexamethylene glycol di(meth)acrylate, nonamethylene glycol di(meth)acrylate, decamethylene glycol di(meth)acrylate, dipropylene glycol di(meth)acrylate, tripropylene glycol di(meth)acrylate, ethylene glycol di(meth)acrylate, diethylene glycol di(meth)acrylate, triethylene glycol di(meth)acrylate, tetraethylene glycol di(meth)acrylate, 1,3 butylene glycol di(meth)acrylate, dipentaerythritol penta/hexa acrylate, trimethylolpropane tri(meth)acrylate, dimethylolpropane tetra(meth)acrylate, 5 moles ethoxylated pentaerythritol tetra(meth)acrylate, hexanediol di(meth)acrylate, glycerol tri(meth)acrylate, glycerol di(meth)acrylate, propoxylated glycerol tri(meth)acrylate, pentaerythritol diacrylate, pentaerythritol triacrylate, pentaerythritol tetraacrylate trimethylolpropane ethoxy triacrylate, neopentyl glycol di(meth)acrylate, neopentyl glycol propoxylate (1 PO/OH) di(meth)acrylate, bisphenol A di(meth)acrylate, 1,3,5-tri(meth)acryloylhexahydro-1,3,5-triazine, tris(2-acryloyloxyethyl)isocyanurate, polyethylene glycol(meth)acrylate, polypropylene glycol(meth)acrylate, or a mixture thereof.

24. The composition according to item 22 or 23, wherein the at least one compound having at least one polymerisable vinylidene group of component (iii) is a reactive diluent.

25. The composition according to any one of the preceding items, wherein the content of component (iii) in the composition is 20-70% by weight, preferably less than 60% by weight, such as 30-55% by weight and in particular 40-50% by weight, based on the total mass of the composition.

26. The composition according to any one of the preceding items, comprising
(i) at least two prepolymers, preferably (cyclo)aliphatic polyurethanes optionally containing one or more urea groups, with at least two polymerisable vinylidene groups,
(ii) at least two photoinitiators, and
(iii) at least two compounds, preferably (cyclo)aliphatic compounds, having at least one, in particular one, polymerisable vinylidene group, wherein component (iii) has a weight average molecular weight M_{w} of 70-800 g/mol, preferably 100-500 g/mol, more preferably 100-450 g/mol.

27. The composition according to any one of the preceding items, wherein the composition is free of water.

28. The composition according to any one of the preceding items, wherein the composition is free of organic solvents, in particular inert organic solvents such as alcohols, e. g. methanol, ethanol, propanol, iso-propanol, butanol, pentanol, hexanol, carboxylic acid esters, e. g. ethyl acetate. e.g. ethyl acetate, iso-propyl acetate, butyl acetate, methoxypropyl acetate, ketones, e.g. acetone, methyl ethyl ketone, dibutyl ketone, cyclohexanone, ethers, e. g. diethyl ether, ethylene glycol monoethyl ether and tert-butyl methyl ether, alkanes, e. g. n-pentane, n-hexane, iso-hexane, n-heptane, octane, iso-octane, special petrol, light petrol, petroleum ether, cyclohexane, aromatic hydrocarbons such as benzene, toluene, xylene, phenol, nitrobenzene, aniline, methyl benzoate, phenyl acetate, halogenated aliphatic hydrocarbons such as dichloromethane, methane and methyl benzoate. such as dichloromethane, chloroform, carbon tetrachloride and dimethylformamide, dimethyl sulfoxide, carbon disulfide, nitroalkanes, diethyl phosphate, sulfolane and mixtures thereof.

29. The composition according to any one of the preceding items, wherein the composition has a viscosity of 1,000-10,000 mPa·s, preferably 2,000-7,500 mPa·s and in particular 2,500-4,500 mPa·s measured at 23° C. according to DIN 2555.

30. The composition according to any one of the preceding items, wherein component (i) and/or component (iii) is free of NCO groups.

31. The composition according to any one of the preceding items, comprising
(i) more than 40-80% by weight, preferably more than 40-70% by weight and more preferably 45-60% by weight of at least one prepolymer having at least two polymerisable vinylidene groups, component (i) having a weight average molecular weight M_{w} of 2000-50000 g/mol, more preferably 4000-10000 g/mol.
(ii) 0.1-15% by weight, preferably 1-10% by weight and more preferably 1-5% by weight of at least one photoinitiator, and
(iii) 20 to less than 60% by weight, preferably 30-55% by weight and in particular 40-50% by weight of at least one compound having at least one, preferably 1-3, polymerisable vinylidene group, component (iii) having a weight average molecular weight M_{w} of 70-800 g/mol, preferably 100-500 g/mol, more preferably 100-450 g/mol.

32. A polymer obtained by irradiation of the composition according to any one of items 1-31.

33. Use of the composition according to any one of items 1-31 for bonding a fibre unit, in particular a yarn, such as a fancy yarn, plain yarn, textured yarn, multiple-wound yarn, spun yarn, rotor yarn, tricylinder yarn, worsted yarn, semi-worsted yarn, carded yarn, schappe yarn, bourette yarn, filament yarn such as multifilament yarn and monofilament yarn, a twine, such as a fancy twine, a single stage twine, multi stage twine, covering twine, continuous twine, a rope, fibres such as short fibres, long fibres, staple fibres and fibre bundles, and filament silk of natural material, semi-synthetic material, synthetic material or a mixture thereof.

34. A method of bonding fibre units comprising the steps of:

(a) providing a composition according to any one of items 1-31,

(b) applying the composition provided in step (a) to at least one fibre unit,

(c) irradiating the fibre unit obtained according to step (b) with radiation, in particular with a wavelength in the range of 100-450 nm.

35. The method according to item 34, wherein the fibre unit in step (b) is selected from a yarn, such as fancy yarn, plain yarn, textured yarn, plied yarn, staple fibre yarn, rotor yarn, tricylinder yarn, worsted yarn, semi-worsted yarn, carded yarn, schappe yarn, bourette yarn, filament yarn, such as multifilament yarn and monofilament yarn, a twine, such as fancy twine, single stage twine, multi stage twine, covering twine, continuous twine, a rope, fibres such as short fibres, long fibres, staple fibres and fibre bundles, and filament silk of natural material, semi-synthetic material, synthetic material and a mixture thereof.

36. The method according to any one of items 34-35, wherein in step (b) the composition is applied in an amount of 1-40, preferably 3-30, more preferably 5-20 by weight based on the weight of the fibre unit.

37. The method according to any one of items 34-36, wherein step (c) is carried out for a period of 0.5-600 s, preferably 0.5-300 s, in particular 1-10 s.

38. A fibre unit obtainable by a process according to any one of items 34-37.

39. A fibre unit comprising a polymer according to item 32.

40. A fibre unit according to item 38 or 39, which has a uniform distribution of the applied composition along its cross-section.

41. A fibre unit according to any one of items 38-40, which has no cratering.

42. Use of the fibre unit according to any one of items 38-41 in the processing of textiles, in particular for sewing shoes, outdoor clothing, jackets, coats, curtains, awnings, tent fabrics, curtains, bags, or backpacks, in the automotive sector, in particular in the processing of airbags, seat covers, belts, boot covers, nets, headrests, armrests, centre consoles, convertible tops, insulation, carpets, floor mats, or in the processing of fitted carpets, rugs, sailcloth, boat covers, tarpaulins and fishing nets.

43. The polymer according to item 32, which has a shore A hardness of 50-100 measured according to DIN 53505.

44. The polymer according to item 32 or 43, which has a pendulum hardness according to Konig of 1-30 s measured according to DIN 53157.

45. The polymer according to item 32 or 42-44, which has an elongation at break of 10-500% measured according to DIN 53504.

1. A composition comprising:
(i) at least one prepolymer having at least two polymerisable vinylidene groups,
(ii) at least one photoinitiator, and
(iii) at least one compound having at least one polymerisable vinylidene group,
wherein component (iii) has a weight average molecular weight of 70-800 g/mol, preferably 100-500 g/mol, more preferably 100-450 g/mol, and
wherein component (i) preferably has a weight average molecular weight M_{w} of 2000-50000 g/mol, more preferably 4000-10000 g/mol.

2. The composition according to claim 1, wherein the polymerisable vinylidene group in the components (i) and (iii) is each independently selected from a (meth)acrylate group, vinyl group and allyl group, in particular a (meth)acrylic acid ester group and (meth)acrylic acid amide group such as a crotonic acid, itaconic acid, fumaric acid, maleic acid, acrylamidoglycolic acid and methacrylamidoglycolic acid ester or amide group.

3. The composition according to claim 1, wherein at least one prepolymer having at least two polymerisable vinylidene groups is obtained by reacting an NCO prepolymer (A) with a compound (B) comprising a polymerisable vinylidene group and an NCO-reactive group.

4. The composition according to claim 1, wherein at least one prepolymer having at least two polymerisable vinylidene groups is obtained by reacting a polyol compound, such as a polyester polyol, polycarbonate polyol or polyether polyol, or a polyepoxidised compound (X1) with a vinylidene-containing carboxylic acid such as (meth)acrylic acid, crotonic acid, itaconic acid, fumaric acid, maleic acid, acrylamidoglycolic acid and methacrylamidoglycolic acid.

5. The composition according to claim 1, wherein component (i) is a polyurethane, a polycarbonate, a polyether, a polyester, a functionalised vegetable oil or a functionalised sugar polymer, in particular a (cyclo)aliphatic polyurethane optionally having one or more urea groups, with at least two polymerisable vinylidene groups, in particular at least two (meth)acrylate groups, or a mixture thereof.

6. The composition according to claim 1, wherein the photoinitiator is a radical photoinitiator, in particular selected from benzophenones, acetophenones, in particular hydroxyacetophenones, thioxanthones, α-dicarbonyl compounds, phenylglyoxalic acids, α-hydroxyketones, phosphine oxides, such as acylphosphine oxide and bis-acylphosphine oxide, acylphosphine sulphides and germanium compounds or a mixture thereof, and the content of component (ii) in the composition is preferably 0.1-15% by weight based on the total mass of the composition.

7. The composition according to claim 1, wherein component (iii) has a viscosity of 1-2,000 mPa·s and preferably 1-500 mPa·s measured at 23° C. according to DIN 2555.

8. The composition according to claim 1, wherein at least one compound having at least one polymerisable vinylidene group of component (iii) is a reactive diluent.

9. The composition according to claim 1, comprising
(i) at least two prepolymers, preferably (cyclo)aliphatic polyurethanes optionally having one or more urea groups, having at least two polymerisable vinylidene groups, wherein component (i) preferably has a weight average molecular weight M_{w} of 2000-50000 g/mol, more preferably 4000-10000 g/mol,
(ii) at least two photoinitiators, and
(iii) at least two compounds, preferably (cyclo)aliphatic compounds, having at least one, in particular a polymerisable vinylidene group, wherein component (iii) has a weight average molecular weight M_{w} of 70-800 g/mol, preferably 100-500 g/mol, more preferably 100-450 g/mol.

10. The composition according to claim 1, wherein the composition is free of water and/or an organic solvent, in particular an inert organic solvent such as alcohols, e. g. methanol, ethanol, propanol, iso-propanol, butanol, pentanol, hexanol, carboxylic acid esters, e.g. ethyl acetate, iso-propyl acetate, butyl acetate, methoxypropyl acetate, ketones, e. g. acetone, methyl ethyl ketone, dibutyl ketone, cyclohexanone, ethers, e. g. diethyl ether, ethylene glycol monoethyl ether and tert-butyl methyl ether, alkanes, such as n-pentane, n-hexane, iso-hexane, n-heptane, octane, iso-octane, special petrol, light petrol, petroleum ether, cyclohexane, aromatic hydrocarbons, such as e. g. benzene, toluene, xylene, phenol, nitrobenzene, aniline, methyl benzoate, phenyl acetate, halogenated aliphatic hydrocarbons such as dichloromethane, chloroform, carbon tetrachloride and dimethylformamide, dimethyl sulphoxide, carbon disulphide, nitroalkanes, diethyl phosphate, sulfolane and mixtures thereof.

11. A polymer which is obtained by irradiation of the composition according to claim 1.

12. Use of the composition according to claim 1 for bonding a fibre unit, in particular a yarn, such as a fancy yarn, plain yarn, textured yarn, plied yarn, staple fibre yarn, rotor yarn, tricylinder yarn, worsted yarn, semi-worsted yarn, carded yarn, schappe yarn, bourette yarn, filament yarn, such as multifilament yarn and monofilament yarn, a twine, such as a fancy twine, single stage twine, multi stage twine, covering twine, continuous twines, a rope, fibres such as short fibres, long fibres, staple fibres and fibre bundles, and filament silk of natural material, semi-synthetic material, synthetic material and a mixture thereof.

13. A method of bonding fibre units comprising the steps of:
(a) providing a composition according to claim 1,
(b) applying the composition provided in step (a) to at least one fibre unit,
(c) irradiating the fibre unit obtained in step (b) with radiation, in particular with a wavelength in the range of 100-450 nm.

14. The fibre unit obtained by a method according to claim 13.

15. Use of the fibre unit according to claim 14 in the processing of textiles, in particular for sewing shoes, outdoor clothing, jackets, coats, curtains, awnings, tent fabrics, curtains, bags, or backpacks, in the automotive sector, in particular in the processing of airbags, seat covers, belts, boot covers, nets, headrests, armrests, centre consoles, convertible tops, insulations, carpets, floor mats, or in the processing of carpets, rugs, sailing fabrics, boat tarpaulins, tarpaulins and fishing nets.
